(19) United States
(12) Patent Application Publication
(10) Pub. No.: US 2024/0259697 A1
(43) Pub. Date: Aug. 1, 2024

(54) IMAGE CAPTURING METHOD, NON-TRANSITORY RECORDING MEDIUM, IMAGE CAPTURING SYSTEM, AND INFORMATION PROCESSING APPARATUS

(71) Applicants: Hibiki Tatsuno, KANAGAWA (JP); Yasuhiro Akita, TOKYO (JP); Sadao Takahashi, KANAGAWA (JP); Ryouji Yamamoto, KANAGAWA (JP)

(72) Inventors: Hibiki Tatsuno, KANAGAWA (JP); Yasuhiro Akita, TOKYO (JP); Sadao Takahashi, KANAGAWA (JP); Ryouji Yamamoto, KANAGAWA (JP)

(73) Assignee: Ricoh Company, Ltd., Tokyo (JP)

(21) Appl. No.: 18/397,328

(22) Filed: Dec. 27, 2023

(30) Foreign Application Priority Data
Jan. 26, 2023 (JP) 2023-010401

(51) Int. Cl. H04N 23/80; H04N 23/73

(52) U.S. Cl. CPC H04N 23/80; H04N 23/73

(57) ABSTRACT

An image capturing method executed by an image capturing device that is mounted on a mobile apparatus and captures an image of an object during movement of the mobile apparatus, the image capturing method comprising: capturing a first image of the object with a first amount of exposure while a relative position between the image capturing device and the object is constantly changing; and capturing a second image of the object with a second amount of exposure different from the first amount of exposure while the relative position between the image capturing device and the object is constantly changing.

### CROSS-REFERENCE TO RELATED APPLICATIONS

This patent application is based on and claims priority pursuant to 35 U.S.C. § 119(a) to Japanese Patent Application No. 2023-010401, filed on Jan. 26, 2023, in the Japan Patent Office, the entire disclosure of which is hereby incorporated by reference herein.

### BACKGROUND

### Technical Field

The present disclosure relates to an image capturing method, a non-transitory recording medium, an image capturing system, and an information processing apparatus.

### Related Art

In the related art, a technique is known for capturing an image of an object such as a road earthwork structure with an image capturing device mounted on a mobile apparatus during movement of the mobile apparatus and inspecting the road earthwork structure by using the captured image. An object such as a road earthwork structure may include a bright area that receives direct sunlight, and a dark area shaded by nearby trees or the like to prevent direct sunlight. In capturing of an image of such an object, in some cases, the difference in amount of exposure between the bright area and the dark area may be large. An image of an object including areas having a large difference in amount of exposure is captured with reduced blocked-up shadows and blown-out highlights in the image by using a wide dynamic range imaging technique.

### SUMMARY

According to an embodiment of the present disclosure, an image capturing method is executed by an image capturing device that is mounted on a mobile apparatus and captures an image of an object during movement of the mobile apparatus. The image capturing method includes capturing a first image of the object with a first amount of exposure while a relative position between the image capturing device and the object is constantly changing; and capturing a second image of the object with a second amount of exposure different from the first amount of exposure while the relative position between the image capturing device and the object is constantly changing.

According to an embodiment of the present disclosure, a non-transitory recording medium stores a plurality of instructions which, when executed by one or more processors, causes the processors to perform the image capturing method.

According to an embodiment of the present disclosure, an image capturing system includes an image capturing device and an information processing apparatus. The image capturing device is mounted on a mobile apparatus and captures an image of an object during movement of the mobile apparatus. The information processing apparatus processes the image captured by the image capturing device. The image capturing device captures a first image of the object with a first amount of exposure, and captures a second image of the object with a second amount of exposure different from the first amount of exposure, while the relative position between the image capturing device and the object is constantly changing.

According to an embodiment of the present disclosure, an information processing apparatus includes circuitry. The circuitry receives a first image and a second image from an image capturing device that is mounted on board a mobile apparatus and captures an image of an object during movement of the mobile apparatus while a relative position between the image capturing device and the object is constantly changing. The first image is an image of the object and captured with a first amount of exposure. The second image is an image of the object and captured with a second amount of exposure different from the first amount of exposure. The circuitry acquires a composite image of the first image and the second image.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a view illustrating an example general arrangement of a state inspection system according to a first embodiment of the present disclosure;

FIG. 2 is an illustration of an example of inspection of the state of a slope using a mobile apparatus system according to the first embodiment;

FIG. 3 is an illustration of an example of a slope including bright and dark areas;

FIG. 4 is a block diagram illustrating an example hardware configuration of a data acquisition apparatus according to an embodiment of the present disclosure;

FIG. 5 is a block diagram illustrating an example hardware configuration of an evaluation apparatus and a data management apparatus according to an embodiment of the present disclosure;

FIG. 6 is a block diagram illustrating an example functional configuration of the state inspection system according to the first embodiment;

FIG. 7 is an illustration of an example of a state type management table according to an embodiment of the present disclosure;

FIG. 8 is an illustration, continued from FIG. 7, of the example of the state type management table;

FIG. 9A is an illustration of an example of an acquired data management table according to an embodiment of the present disclosure;

FIG. 9B is an illustration of an example of a processed data management table according to an embodiment of the present disclosure;

FIG. 10 is an illustration describing a captured image acquired by the mobile apparatus system according to an embodiment of the present disclosure;

FIG. 11A and FIG. 11B are illustrations describing a captured image and a distance measurement image, respectively, according to an embodiment of the present disclosure;

FIG. 12 is a sequence chart illustrating an example of data acquisition processing using the mobile apparatus system according to an embodiment of the present disclosure;

FIG. 13 is a sequence chart illustrating an example process for generating evaluation target data according to an embodiment of the present disclosure;

FIG. 14 is a sequence chart illustrating an example process for generating a report as a result of evaluation of the state of the slope according to an embodiment of the present disclosure;

FIG. 15 is a view illustrating an example of an evaluation screen displayed on the evaluation apparatus according to an embodiment of the present disclosure;

FIG. 16 is a view illustrating an example of the evaluation screen on which processed data is displayed, according to an embodiment of the present disclosure;

FIG. 17 is a flowchart illustrating an example of processing for detecting the state of the slope according to an embodiment of the present disclosure;

FIG. 18 is a view illustrating an example of the evaluation screen on which shape data indicating a detection result is displayed, according to an embodiment of the present disclosure;

FIG. 19 is a view illustrating an example of a display screen indicating a damage detection result according to an embodiment of the present disclosure;

FIG. 20 is an illustration of an example of a cross-sectional image of a detected slope shape according to an embodiment of the present disclosure;

FIG. 21 is an illustration of an example situation for capturing a first image and a second image according to the first embodiment;

FIG. 22 is an illustration of an example of the first image according to the first embodiment;

FIG. 23 is an illustration of an example of the second image according to the first embodiment;

FIG. 24 is an illustration of an example of a composite image of the first image illustrated in FIG. 22 and the second image illustrated in FIG. 23;

FIG. 25 is an illustration of an example situation for capturing a first image according to a second embodiment of the present disclosure;

FIG. 26 is an illustration of an example situation for capturing a second image according to the second embodiment;

FIG. 27 is an illustration of a position of the mobile apparatus according to an embodiment of the present disclosure;

FIG. 28 is an illustration of an example situation for capturing a first image according to a third embodiment of the present disclosure;

FIG. 29 is an illustration of an example situation for capturing a second image according to the third embodiment;

FIG. 30 is an illustration of an example of a difference in the size of an image area corresponding to an object between the first image and the second image according to the third embodiment;

FIG. 31 is an illustration of an example of a change of the size of the image area corresponding to the object according to the third embodiment;

FIG. 32 is an illustration of an example of a first image according to a fourth embodiment of the present disclosure;

FIG. 33 is an illustration of a brightness distribution over a cross section taken along line XXXIII-XXXIII of FIG. 32;

FIG. 34 is an illustration of an example of a second image according to the fourth embodiment;

FIG. 35 is an illustration of a brightness distribution over a cross section taken along line XXXV-XXXV of FIG. 34;

FIG. 36 is an illustration of an example of a composite image of the first image illustrated in FIG. 32 and the second image illustrated in FIG. 34;

FIG. 37 is an illustration of a brightness distribution over a cross section taken along line XXXVII-XXXVII of FIG. 36;

FIG. 38 is an illustration of an example of a result of subjecting the composite image illustrated in FIG. 36 to brightness correction; and

FIG. 39 is an illustration of a brightness distribution over a cross section taken along line XXXIX-XXXIX of FIG. 38.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

### First Embodiment

### Example General Arrangement of State Inspection System 1

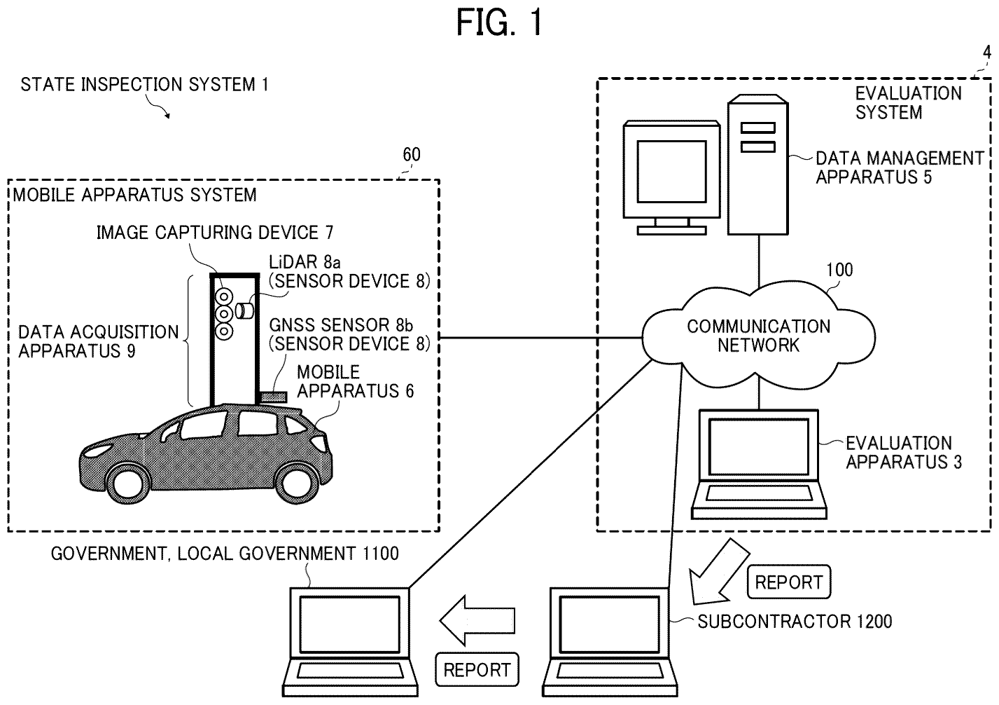

A general arrangement of a state inspection system 1 according to a first embodiment will be described with reference to FIGS. 1 to 3. FIG. 1 is a view illustrating an example general arrangement of the state inspection system 1 according to the first embodiment.

The state inspection system 1 inspects the state of a road earthwork structure by using various types of data acquired by a mobile apparatus system 60. The road earthwork structure is a term that collectively refers to structures made of ground materials, such as earth, sand, gravel, stones, and rocks, as a main material to construct a road, and related structures. Examples of the road earthwork structure include facilities for stabilizing cut slopes and slopes, embankments, culverts, and similar structures. In the following description, the road earthwork structure is referred to as a “man-made slope” or simply a “slope”. The slope is an example of an object. The state inspection system 1 is an example of an image capturing system.

As illustrated in FIG. 1, the state inspection system 1 includes the mobile apparatus system 60, an evaluation system 4, a terminal apparatus 1100 for a government or a local government, and a terminal apparatus 1200 for a subcontractor. The mobile apparatus system 60 includes a data acquisition apparatus 9 and a mobile apparatus 6 equipped with the data acquisition apparatus 9. Examples of the mobile apparatus 6 include a vehicle. The data acquisition apparatus 9 includes an image capturing device 7 and a sensor device 8. The image capturing device 7 is an example of a measurement device that measures a structure. The sensor device 8 includes a distance sensor 8a and a global navigation satellite system (GNSS) sensor 8b. GNSS is a term that collectively refers to satellite positioning systems such as a global positioning system (GPS) or quasi-zenith satellite system (QZSS).

The image capturing device 7 is mounted on the mobile apparatus 6 and captures an image of a slope during movement of the mobile apparatus 6. The image capturing device 7 is a line camera including a line sensor having one or more rows of photoelectric conversion elements. The image capturing device 7 captures an image of an object in a certain location along a predetermined image-capturing range on an image-capturing surface in a direction of travel of the mobile apparatus 6. The line camera is merely one example of the image capturing device 7. In another example, the image capturing device 7 may be a camera including an area sensor having photoelectric conversion elements arranged in a plane. In one example, the image capturing device 7 may include multiple cameras.

The distance sensor 8a is an example of a three-dimensional sensor that measures the three-dimensional surface shape of the slope. The distance sensor 8a is a time of flight (ToF) sensor that measures a distance from an object of which an image is captured by the image capturing device 7. The ToF sensor used as the distance sensor 8a emits laser light to an object from a light source and measures light scattered or reflected from the object to measure a distance from the light source to the object. In one example, the distance sensor 8a is a light detection and ranging (LiDAR) sensor. The LiDAR sensor is a distance sensor based on a method for the measurement of light flight time using pulses. In another example, the distance sensor 8a may be a sensor based on a phase difference detection method. In the phase difference detection method, the distance sensor 8a irradiates a measurement range with laser light that is amplitude-modulated at a fundamental frequency. The distance sensor 8a receives light reflected from an object irradiated with laser light emitted from the light source and measures the phase difference between the emitted light and the reflected light to determine time. Further, the distance sensor 8a multiplies the time by the speed of light to calculate the distance from the light source to the object. In another example, the distance sensor 8a may include, for example, a stereo camera.

The GNSS sensor 8b is a position measuring means that measures a position on the earth by receiving signals transmitted from multiple GNSS satellites at multiple times and calculating distances to the satellites based on differences from the times at which the signals are received. The position measuring means may be a device dedicated to position measurement, or an application dedicated to position measurement and installed in, for example, a personal computer (PC) or a smartphone.

The mobile apparatus system 60 includes a three-dimensional sensor. With this configuration, the mobile apparatus system 60 can obtain three-dimensional information that is difficult to obtain from a two-dimensional image. Examples of the three-dimensional information include the height of the slope, the inclination angle of the slope, and a protrusion from the slope. The mobile apparatus system 60 may further include an angle sensor 8c. Examples of the angle sensor 8c include a gyroscopic sensor for detecting an angle (position) or angular velocity (or each acceleration) of the image capturing device 7 in the image capturing direction of the image capturing device 7.

The evaluation system 4 includes an evaluation apparatus 3 and a data management apparatus 5. The evaluation apparatus 3 and the data management apparatus 5 can communicate with the mobile apparatus system 60, the terminal apparatus 1100, and the terminal apparatus 1200 via a communication network 100. The communication network 100 is implemented by the Internet, a mobile communication network, a local area network (LAN), or the like. The communication network 100 may include a wired communication network and a wireless communication network. The wireless communication network may be based on a wireless communication standard such as third generation (3G), fourth generation (4G), fifth generation (5G), Wireless Fidelity (Wi-Fi®), Worldwide Interoperability for Microwave Access (WiMAX), or Long Term Evolution (LTE). The evaluation apparatus 3 and the data management apparatus 5 may each have a communication function based on short-range communication technology such as near field communication (NFC®).

The data management apparatus 5 is an example of an information processing apparatus that processes an image captured by the image capturing device 7. The data management apparatus 5 is a computer such as a PC that manages various types of data acquired by the data acquisition apparatus 9. The data management apparatus 5 receives various types of acquired data from the data acquisition apparatus 9 and transfers the received various types of acquired data to the evaluation apparatus 3 to perform data analysis. The various types of acquired data may be transferred manually from the data management apparatus 5 to the evaluation apparatus 3 by using, for example, a universal serial bus (USB) memory.

The evaluation apparatus 3 is a computer such as a PC that evaluates the state of the slope based on the various types of acquired data transferred from the data management apparatus 5. The evaluation apparatus 3 is installed with a dedicated application program for evaluating the state of the slope. The evaluation apparatus 3 detects the type or structure of the slope from captured-image data and sensor data to extract shape data, and performs detailed analysis such as detecting the presence or absence of a defect and the degree of the defect. Further, the evaluation apparatus 3 generates a report by using the captured-image data, the sensor data, evaluation target data, and the results of the detailed analysis. The report is to be submitted to an entity that manages roads, such as the government, the local government, or the subcontractor. Data of the report generated by the evaluation apparatus 3 is submitted to the government or the local government via the subcontractor in the form of electronic data or a printed document. The report generated by the evaluation apparatus 3 is referred to as a “survey record sheet,” a “check list,” a “survey profile,” or “records”, for example. The PC is merely one example of the evaluation apparatus 3. In another example, the evaluation apparatus 3 may be a smartphone, a tablet terminal, or the like. In the evaluation system 4, the evaluation apparatus 3 and the data management apparatus 5 maybe implemented as a single apparatus or terminal.

The terminal apparatus 1200 is installed at the subcontractor. The terminal apparatus 1100 is installed at the government or the local government. The evaluation apparatus 3, the terminal apparatus 1100, and the terminal apparatus 1200 are examples of a communication terminal that can communicate with the data management apparatus 5. Various types of data managed by the data management apparatus 5 is viewable on the evaluation apparatus 3, the terminal apparatus 1100, and the terminal apparatus 1200.

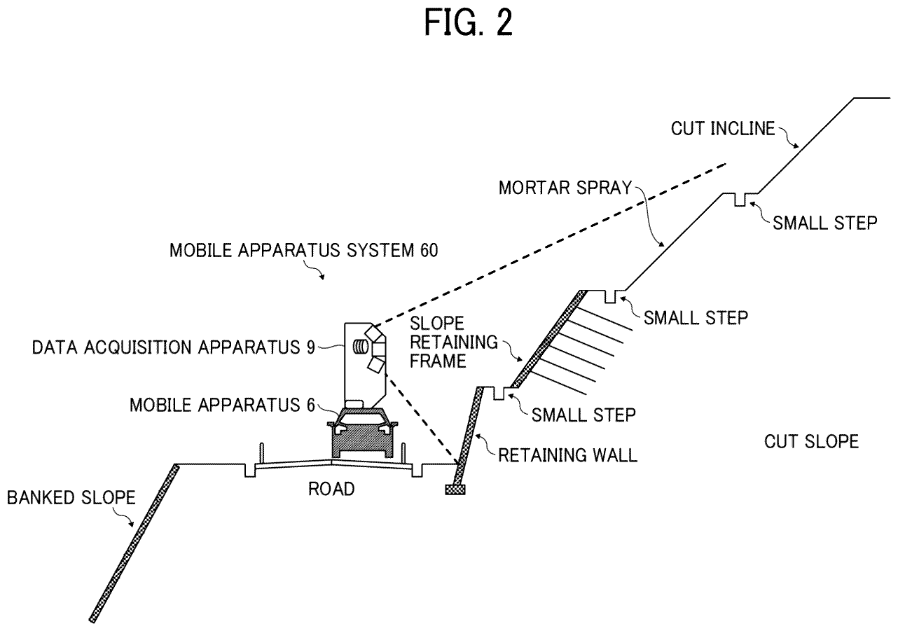

FIG. 2 is an illustration of an example of inspection of the state of a slope using the mobile apparatus system 60. In the mobile apparatus system 60, the image capturing device 7 captures images of a predetermined range of the slope while the mobile apparatus 6 equipped with the data acquisition apparatus 9 is traveling on a road.

Of slopes, an inclined surface created by excavation is referred to as a “cut slope”, and an inclined surface on which soil is heaped is referred to as a “banked slope”. An inclined surface on a side of a road running through a mountain valley is referred to as a “natural slope”. Vegetation cover can improve the durability of cut slopes and banked slopes and may allow the slopes to remain unchanged for several decades. However, in other cases, as the deterioration of cut slopes, banked slopes, and natural slopes progresses due to wind, rain, and other environmental factors, a landslide or a surface layer collapse in which the loose rock and soil on the surface slide may occur. This may cause a collapse leading to a road blockage. Some methods are adopted to avoid such a situation. Examples of such methods include spraying mortar over a slope face (mortar spraying), and installing a concrete structure on a slope to harden the slope to slow down the deterioration of the slope caused by weathering. Structures constructed by the methods described above each correspond to the road earthwork structure described above, or a slope. In one example, a man-made slope is supported with a retaining wall that is installed between a natural slope and a road. In another example, a rockfall protection fence or the like is installed on a man-made slope to prevent rocks from falling onto a road. Such an earthwork structure is for preventing road blockage or human injury caused by, for example, the movement of earth and sand or rockfall onto the road.

Slopes constructed several decades ago have markedly deteriorated, and the maintenance of social infrastructure has recently been a major issue. For this reason, deterioration of the slopes is detected at an early stage. Further, inspection and maintenance against aging are performed to extend the life of the slopes. Existing inspection of natural slopes and man-made slopes includes investigating rockslides, collapses, landslides, or debris flows on slopes to prepare a repair plan. In the related art, the inspection is performed by visual inspections by experts.

However, visual inspections by experts have drawbacks in terms of efficiency, such as the inability to inspect many man-made slopes across the country in a certain period of time, and the impossibility of inspecting embankments at high places or along rivers. Visual inspections also have drawbacks in that the degree of progress of deterioration of defects such as cracks or separations in surface layers of man-made slopes is difficult to quantitatively recognize.

In the state inspection system 1, the image capturing device 7 acquires captured-image data of a slope, and the three-dimensional sensor such as the distance sensor 8a acquires sensor data including three-dimensional information. The evaluation system 4 combines the acquired captured-image data and sensor data to evaluate the state of the slope. As a result, the evaluation system 4 detects shape data indicating the three-dimensional shape of the slope and detects a defect such as a crack or a separation. Accordingly, the state inspection system 1 enables efficient evaluation that is difficult to perform by human visual inspection.

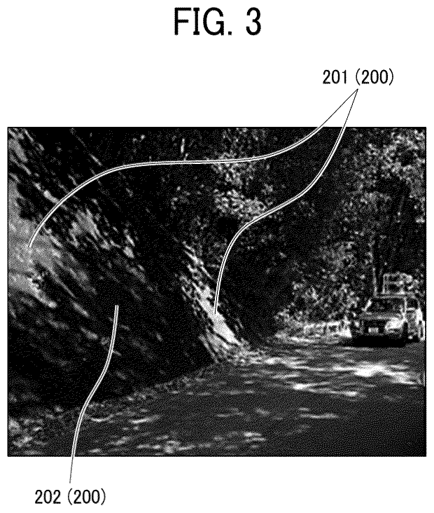

A slope may include a bright area that receives direct sunlight, and a dark area shaded by nearby trees or the like to prevent direct sunlight. In capturing of an image of the slope, in some cases, the difference in amount of exposure between the bright area of the slope and the dark area of the slope may be large. FIG. 3 is an illustration of an example of a slope 200 including bright areas 201 and a dark area 202. In FIG. 3, a captured image of the slope 200 is obtained by an image capturing device different from the image capturing device 7, and is illustrated to describe the bright areas 201 and the dark area 202.

As illustrated in FIG. 3, the bright areas 201 have higher brightness than the dark area 202. In capturing of an image of the slope 200, the brightness of the bright areas 201 may be 10 times or more the brightness of the dark area 202. Due to such a large difference in brightness, the difference in amount of exposure between the bright areas 201 and the dark area 202 is large in capturing of an image of the slope 200. An image of a slope including areas having a large difference in amount of exposure is captured with reduced blocked-up shadows and blown-out highlights in the image by using a wide dynamic range imaging technique. An image capturing device for capturing an image of a slope typically includes a color imaging element to, for example, identify vegetation on the slope. Since the dynamic range of a color imaging element is about several times greater, an image of a slope including a brightness difference greater than or equal to 10 times may be difficult to capture with reduced blocked-up shadows and blown-out highlights in the image. Japanese Unexamined Patent Application Publication Nos. 2017-120971, 2021-013131, and 2012-230486 disclose an image capturing technique with a wide dynamic range, but do not disclose that a plurality of captured images with different amounts of exposure are obtained while a relative position between an image capturing device and an object is constantly changing.

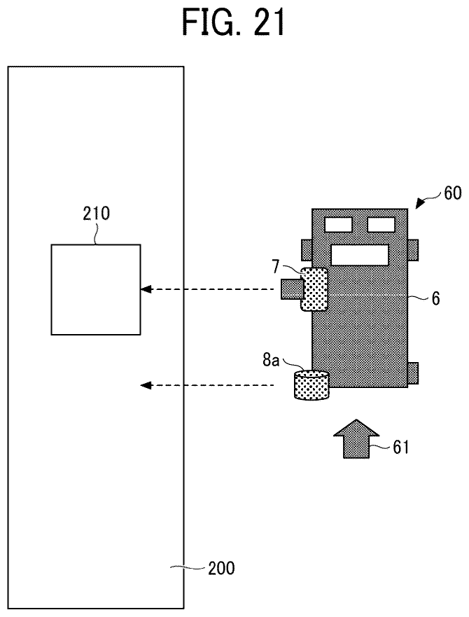

In the present embodiment, while the relative position between the image capturing device 7 and the slope (object) is constantly changing, the image capturing device 7 captures a first image of the slope with a first amount of exposure and captures a second image of the slope with a second amount of exposure different from the first amount of exposure. As a result, a plurality of captured images with different amounts of exposure, including the first image and the second image, can be obtained while the relative position between the image capturing device 7 and the slope is constantly changing. As used herein, the phrase “relative position between the image capturing device 7 and the slope” is used to include the relative position in the direction of travel of the mobile apparatus 6 and the relative position in a direction intersecting the direction of travel of the mobile apparatus 6. As used herein, the phrase “while the relative position between the image capturing device 7 and the slope is changing” refers to a state in which at least one of the relative position in the direction of travel of the mobile apparatus 6 and the relative position in a direction intersecting the direction of travel of the mobile apparatus 6 is changing. The details of an image capturing method and the like according to the present embodiment will be described with reference to mainly FIG. 21 and the subsequent drawings.

### Example Hardware Configuration

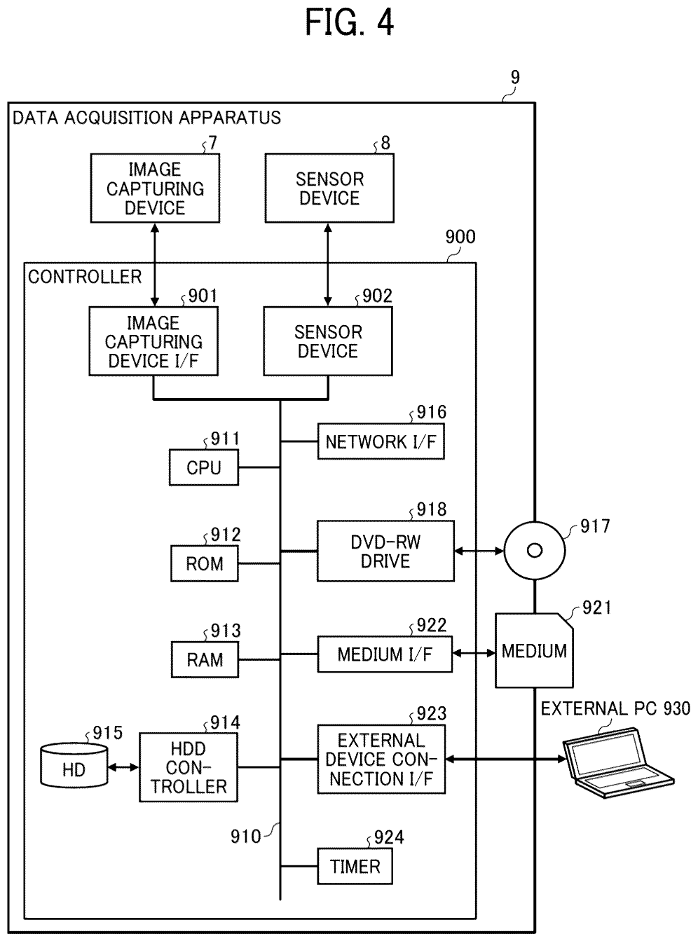

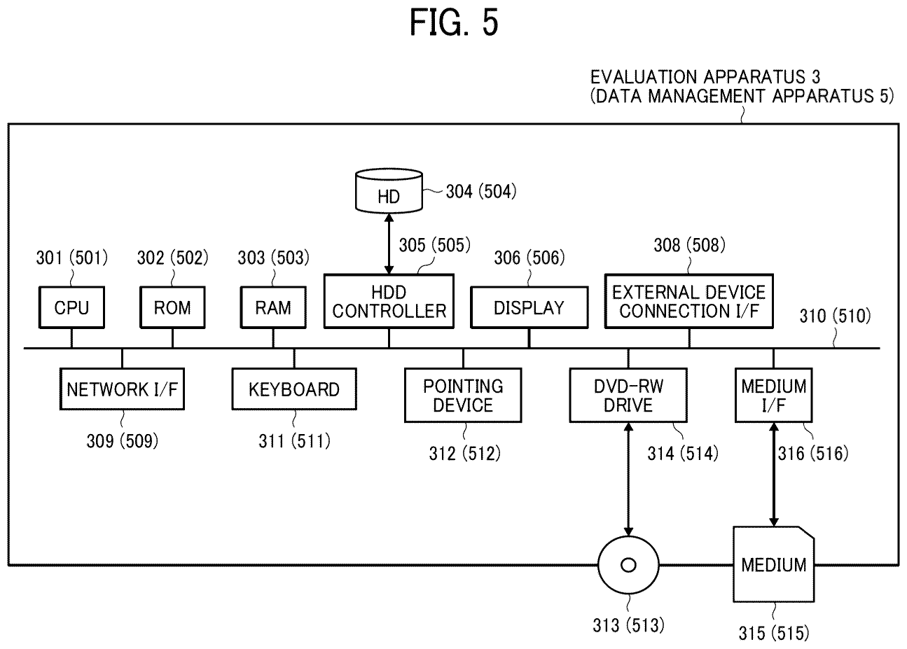

The hardware configuration of the apparatuses included in the state inspection system 1 will be described with reference to FIGS. 4 and 5. In the hardware configurations illustrated in FIGS. 4 and 5, certain hardware elements may be added or deleted as appropriate.

### Hardware Configuration of Data Acquisition Apparatus 9

FIG. 4 is a block diagram illustrating an example hardware configuration of the data acquisition apparatus 9. The data acquisition apparatus 9 includes the image capturing device 7 and the sensor device 8 illustrated in FIG. 1. The data acquisition apparatus 9 further includes a controller 900 that controls processing or operation of the data acquisition apparatus 9.

The controller 900 includes an image capturing device interface (I/F) 901, a sensor device I/F 902, a bus line 910, a central processing unit (CPU) 911, and a read only memory (ROM) 912.

The controller 900 further includes a random access memory (RAM) 913, a hard disk (HD) 914, a hard disk drive (HDD) controller 915, and a network I/F 916. The controller 900 further includes a digital versatile disc rewritable (DVD-RW) drive 918, a medium I/F 922, an external device connection I/F 923, and a timer 924.

The image capturing device I/F 901 is an interface through which the controller 900 transmits and receives various types of data or information to and from the image capturing device 7. The sensor device I/F 902 is an interface through which the controller 900 transmits and receives various types of data or information to and from the sensor device 8. The bus line 910 is an address bus, a data bus, or the like through which the components such as the CPU 911 are electrically connected to each other.

The CPU 911 controls the overall operation of the data acquisition apparatus 9. The ROM 912 stores a program such as an initial program loader (IPL) for driving the CPU 911. The RAM 913 is used as a work area for the CPU 911. The HD 914 stores various types of data such as programs. The HDD controller 915 controls reading or writing of various types of data from or to the HD 914 under control of the CPU 911. The network I/F 916 is an interface for data communication through the communication network 100. The DVD-RW drive 918 controls reading or writing of various types of data from or to a DVD-RW 917, which is an example of a removable recording medium. The DVD-RW 917 is merely one example of the removable recording medium. In another example, any other removable recording medium such as a digital versatile disc-recordable (DVD-R) or a Blu-ray Disc® may be used. The medium I/F 922 controls reading or writing (storing) of data from or to a recording medium 921 such as a flash memory. The external device connection I/F 923 is an interface for connecting the data acquisition apparatus 9 to an external device such as an external PC 930 including a display, a receiving unit, and a display control unit. The timer 924 is a measurement device having a time measurement function. The timer 924 may be a computer-based software timer.

### Hardware Configuration of Evaluation Apparatus 3

FIG. 5 is a block diagram illustrating an example hardware configuration of the evaluation apparatus 3. The hardware components of the evaluation apparatus 3 are denoted by reference numerals in 300 series. As illustrated in FIG. 5, the evaluation apparatus 3 is implemented by a computer. The evaluation apparatus 3 includes a CPU 301, a ROM 302, a RAM 303, an HD 304, an HDD controller 305, a display 306, and an external device connection I/F 308. The evaluation apparatus 3 further includes a network I/F 309, a bus line 310, a keyboard 311, a pointing device 312, a DVD-RW drive 314, and a medium I/F 316.

The CPU 301 controls the overall operation of the evaluation apparatus 3. The ROM 302 stores a program such as an IPL for driving the CPU 301. The RAM 303 is used as a work area for the CPU 301. The HD 304 stores various types of data such as programs. The HDD controller 305 controls reading or writing of various types of data from or to the HD 304 under control of the CPU 301. The display 306 displays various types of information such as a cursor, a menu, a window, text, or an image. The display 306 is an example of a display unit. The external device connection I/F 308 is an interface for connecting the evaluation apparatus 3 to various external devices. The external devices include, for example, but are not limited to, a USB memory and a printer.

The network I/F 309 is an interface for data communication through the communication network 100. The bus line 310 is an address bus, a data bus, or the like through which the components such as the CPU 301 are electrically connected to each other.

The keyboard 311 is an example of an input device including a plurality of keys that allow a user to input characters, numerical values, or various instructions. The pointing device 312 is an example of an input device that allows a user to select or execute various instructions, select a target for processing, or move a cursor being displayed. The DVD-RW drive 314 controls reading or writing of various types of data from or to a DVD-RW 313, which is an example of a removable recording medium. The DVD-RW 313 is merely one example of the removable recording medium. In another example, any other removable recording medium such as a DVD-R or a Blu-ray Disc® may be used. The medium I/F 316 controls reading or writing (storing) of data from or to a recording medium 315 such as a flash memory.

### Hardware Configuration of Data Management Apparatus 5

FIG. 5 is a block diagram illustrating an example hardware configuration of the data management apparatus 5. The hardware components of the data management apparatus 5 are denoted by reference numerals in 500 series in parentheses. As illustrated in FIG. 5, the data management apparatus 5 is implemented by a computer. Since the data management apparatus 5 has a configuration similar to that of the evaluation apparatus 3, the description of the hardware components thereof will be omitted. Each of the terminal apparatus 1100 and the terminal apparatus 1200 is also implemented by a computer and has a configuration similar to that of the evaluation apparatus 3. The description of the hardware components of the terminal apparatus 1100 and the terminal apparatus 1200 will be omitted to avoid redundancy.

Each of the programs described above may be recorded as a file in a format installable or executable on a computer-readable recording medium for distribution. Examples of the recording medium include a compact disc recordable (CD-R), a digital versatile disc (DVD), a Blu-ray Disc®, a Secure Digital (SD) card, and a USB memory. Such recording media may be provided in the domestic or global markets as program products. In one example, the evaluation system 4 according to the present embodiment executes a program according to an embodiment of the present disclosure to implement an evaluation method according to an embodiment of the present disclosure.

### Example Functional Configuration of State Inspection System 1

The functional configuration of the state inspection system 1 will be described with reference to FIG. 6. FIG. 6 is a block diagram illustrating an example functional configuration of the state inspection system 1. FIG. 6 illustrates components included in the apparatuses illustrated in FIG. 1 and related to processing or operation described below.

In one example, the data management apparatus 5 includes a generation unit 54 and a combining unit 55. In another example, a member other than the data management apparatus 5, such as the image capturing device 7 or the data acquisition apparatus 9, may include the generation unit 54 and the combining unit 55.

### Functional Configuration of Data Acquisition Apparatus 9

The functional configuration of the data acquisition apparatus 9 will be described with reference to FIG. 6. The data acquisition apparatus 9 includes a communication unit 91, a determination unit 92, an image capturing device control unit 93, a sensor device control unit 94, a captured image data acquisition unit 95, a sensor data acquisition unit 96, a time data acquisition unit 97, a request receiving unit 98, and a storing and reading unit 99. These components are functions or means implemented by or caused to function in response to one or more of the hardware components illustrated in FIG. 4 operating in accordance with instructions from the CPU 911 according to a data acquisition apparatus program loaded onto the RAM 913 from the HD 914. The data acquisition apparatus 9 further includes a storage unit 9000 implemented by the ROM 912 and the HD 914 illustrated in FIG. 4. The external PC 930 connected to the data acquisition apparatus 9, which is illustrated in FIG. 4, includes a receiving unit and a display control unit.

The communication unit 91 is implemented by the network I/F 916 that operates in accordance with instructions from the CPU 911. The communication unit 91 communicates various types of data or information to and from other apparatuses through the communication network 100. For example, the communication unit 91 transmits acquired data obtained by the captured image data acquisition unit 95 and the sensor data acquisition unit 96 to the data management apparatus 5. The determination unit 92 is implemented by instructions from the CPU 911. The determination unit 92 performs various determinations.

The image capturing device control unit 93 is implemented by the image capturing device I/F 901 that operates in accordance with instructions from the CPU 911. The image capturing device control unit 93 controls image capturing processing to be performed by the image capturing device 7. The image capturing processing controlled by the image capturing device control unit 93 includes processing for adjusting the amount of exposure of the image capturing device 7. The image capturing device 7 can capture the first image of the slope and the second image of the slope with different amounts of exposure controlled by the image capturing device control unit 93. The sensor device control unit 94 is implemented by the sensor device I/F 902 that operates in accordance with instructions from the CPU 911. The sensor device control unit 94 controls the sensor device 8 to perform data acquisition processing.

The captured image data acquisition unit 95 is implemented by the image capturing device I/F 901 that operates in accordance with instructions from the CPU 911. The captured image data acquisition unit 95 acquires captured-image data corresponding to images captured by the image capturing device 7. The images captured by the image capturing device 7 include the first image and the second image. The sensor data acquisition unit 96 is implemented by the sensor device I/F 902 that operates in accordance with instructions from the CPU 911. The sensor data acquisition unit 96 acquires sensor data, which is obtained as a result of detection performed by the sensor device 8. The time data acquisition unit 97 is implemented by the timer 924 that operates in accordance with instructions from the CPU 911. The time data acquisition unit 97 acquires time data indicating a time at which the captured image data acquisition unit 95 or the sensor data acquisition unit 96 acquires data.

The request receiving unit 98 is implemented by the external device connection I/F 923 that operates in accordance with instructions from the CPU 911. The request receiving unit 98 receives a predetermined request from, for example, the external PC 930.

The storing and reading unit 99 is implemented by instructions from the CPU 911. The storing and reading unit 99 stores various types of data (or information) in the storage unit 9000 or reads various types of data (or information) from the storage unit 9000.

### Functional Configuration of Evaluation Apparatus 3

The functional configuration of the evaluation apparatus 3 will be described with reference to FIG. 6. The evaluation apparatus 3 includes a communication unit 31, a receiving unit 32, a display control unit 33, a determination unit 34, an evaluation target data generation unit 35, a detection unit 36, a map data management unit 37, a report generation unit 38, and a storing and reading unit 39. These components are functions or means implemented by or caused to function in response to one or more of the hardware components illustrated in FIG. 5 operating in accordance with instructions from the CPU 301 according to an evaluation apparatus program loaded onto the RAM 303 from the HD 304. The evaluation apparatus 3 further includes a storage unit 3000 implemented by the ROM 302 and the HD 304 illustrated in FIG. 5.

The communication unit 31 is implemented by the network I/F 309 that operates in accordance with instructions from the CPU 301. The communication unit 31 communicates various types of data or information to and from other apparatuses through the communication network 100. For example, the communication unit 31 transmits and receives various types of data for the evaluation of the state of the slope to and from the data management apparatus 5.

The receiving unit 32 is implemented by the keyboard 311 or the pointing device 312 that operates in accordance with instructions from the CPU 301. The receiving unit 32 receives various selections or inputs from the user. The receiving unit 32 receives various selections or inputs on an evaluation screen 400 described below. The display control unit 33 is implemented by instructions from the CPU 301. The display control unit 33 controls the display 306 to display various images. The display control unit 33 causes the display 306 to display the evaluation screen 400 described below. The determination unit 34 is implemented by instructions from the CPU 301. The determination unit 34 performs various determinations.

The evaluation target data generation unit 35 is implemented by instructions from the CPU 301. The evaluation target data generation unit 35 generates data to be evaluated. The data to be evaluated may be referred to as “evaluation target data”. The detection unit 36 is implemented by instructions from the CPU 301. The detection unit 36 performs processing for detecting the state of the slope by using the evaluation target data generated by the evaluation target data generation unit 35. The map data management unit 37 is implemented by instructions from the CPU 301. The map data management unit 37 manages map information acquired from, for example, an external server. The map information includes location information indicating a certain location on a map.

The report generation unit 38 is implemented by instructions from the CPU 301. The report generation unit 38 generates an evaluation report based on an evaluation result. The evaluation report is to be submitted to the entity that manages roads.

The storing and reading unit 39 is implemented by instructions from the CPU 301. The storing and reading unit 39 stores various types of data (or information) in the storage unit 3000 or reads various types of data (or information) from the storage unit 3000.

### Functional Configuration of Data Management Apparatus 5

Next, the functional configuration of the data management apparatus 5 will be described with reference to FIG. 6. The data management apparatus 5 includes a communication unit 51, a determination unit 52, a data management unit 53, a generation unit 54, a combining unit 55, and a storing and reading unit 59. These components are functions or means implemented by or caused to function in response to one or more of the hardware components illustrated in FIG. 5 operating in accordance with instructions from the CPU 501 according to a data management apparatus program loaded onto the RAM 503 from the HD 504. The data management apparatus 5 further includes a storage unit 5000 implemented by the ROM 502 and the HD 504 illustrated in FIG. 5.

The communication unit 51 is implemented by the network I/F 509 that operates in accordance with instructions from the CPU 501. The communication unit 51 communicates various types of data or information to and from other apparatuses through the communication network 100. For example, the communication unit 51 receives captured-image data and sensor data transmitted from the data acquisition apparatus 9. The communication unit 51 further transmits and receives various types of data for the evaluation of the state of the slope, for example, to and from the evaluation apparatus 3, for example. The determination unit 52 is implemented by instructions of the CPU 501. The determination unit 52 performs various determinations.

The data management unit 53 is implemented by instructions from the CPU 501. The data management unit 53 manages various types of data for the evaluation of the state of the slope. For example, the data management unit 53 registers captured-image data and sensor data transmitted from the data acquisition apparatus 9 in an acquired data management database (DB) 5001. For example, the data management unit 53 further registers data processed or generated by the evaluation apparatus 3 in a processed data management DB 5003.

The generation unit 54 is implemented by instructions from the CPU 501. The generation unit 54 generates various types of image data related to the slope. In the present embodiment, the generation unit 54 corresponds to an image generation means for generating a plurality of cross-sectional images related to a cross section of the slope, based on the first image and the second image captured by the image capturing device 7. In the present embodiment, furthermore, the generation unit 54 corresponds to an image generation means for generating a plurality of three-dimensional surface images of the slope, based on the three-dimensional surface shape measured by the distance sensor 8a.

The combining unit 55 corresponds to an image combining means for acquiring a composite image of the first image and the second image captured by the image capturing device 7. The combining unit 55 can output the composite image to the evaluation apparatus 3 through the communication unit 51 and the communication network 100, for example.

The storing and reading unit 59 is implemented by instructions of the CPU 501. The storing and reading unit 59 stores various types of data (or information) in the storage unit 5000 or reads various types of data (or information) from the storage unit 5000.

### Functional Configuration of Terminal Apparatus 1100

The functional configuration of the terminal apparatus 1100 will be described with reference to FIG. 6. The terminal apparatus 1100 includes a communication unit 1101, a receiving unit 1102, a display control unit 1103, a determination unit 1104, and a storing and reading unit 1105. These components are functions or means implemented by or caused to function in response to one or more of the hardware components of the terminal apparatus 1100, which correspond to those illustrated in FIG. 5, operating in accordance with instructions from the CPU according to a terminal apparatus program loaded onto the RAM from the HD. The terminal apparatus 1100 further includes a storage unit 1106 implemented by the HD and the ROM of the terminal apparatus 1100, which correspond to those illustrated in FIG. 5.

The communication unit 1101 is implemented by the network I/F that operates in accordance with instructions from the CPU. The communication unit 1101 communicates various types of data or information to and from other apparatuses through the communication network 100.

The receiving unit 1102 is implemented by the keyboard or the pointing device of the terminal apparatus 1100 that operates in accordance with instructions from the CPU. The receiving unit 1102 receives various selections or inputs from the user. The display control unit 1103 is implemented by instructions from the CPU. The display control unit 1103 causes the display of the terminal apparatus 1100 to display various images. The determination unit 1104 is implemented by instructions from the CPU. The determination unit 1104 performs various determinations.

The storing and reading unit 1105 is implemented by instructions from the CPU. The storing and reading unit 1105 stores various types of data (or information) in the storage unit 1106 or reads various types of data (or information) from the storage unit 1106.

Next, the functional configuration of the terminal apparatus 1200 will be described with reference to FIG. 6. The terminal apparatus 1200 includes a communication unit 1201, a receiving unit 1202, a display control unit 1203, a determination unit 1204, and a storing and reading unit 1205. These components are functions or means implemented by or caused to function in response to one or more of the hardware components of the terminal apparatus 1200, which correspond to those illustrated in FIG. 5, operating in accordance with instructions from the CPU according to a terminal apparatus program loaded onto the RAM from the HD. The terminal apparatus 1200 further includes a storage unit 1206 implemented by the HD and the ROM of the terminal apparatus 1200, which correspond to those illustrated in FIG. 5.

The communication unit 1201 is implemented by the network I/F that operates in accordance with instructions from the CPU. The communication unit 1201 communicates various types of data or information to and from other apparatuses through the communication network 100.

The receiving unit 1202 is implemented by the keyboard or the pointing device of the terminal apparatus 1200 that operates in accordance with instructions from the CPU. The receiving unit 1202 receives various selections or inputs from the user. The display control unit 1203 is implemented by instructions from the CPU. The display control unit 1203 causes the display of the terminal apparatus 1200 to display various images. The determination unit 1204 is implemented by instructions from the CPU. The determination unit 1204 performs various determinations.

The storing and reading unit 1205 is implemented by instructions from the CPU. The storing and reading unit 1205 stores various types of data (or information) in the storage unit 1206 or reads various types of data (or information) from the storage unit 1206.

### State Type Management Table

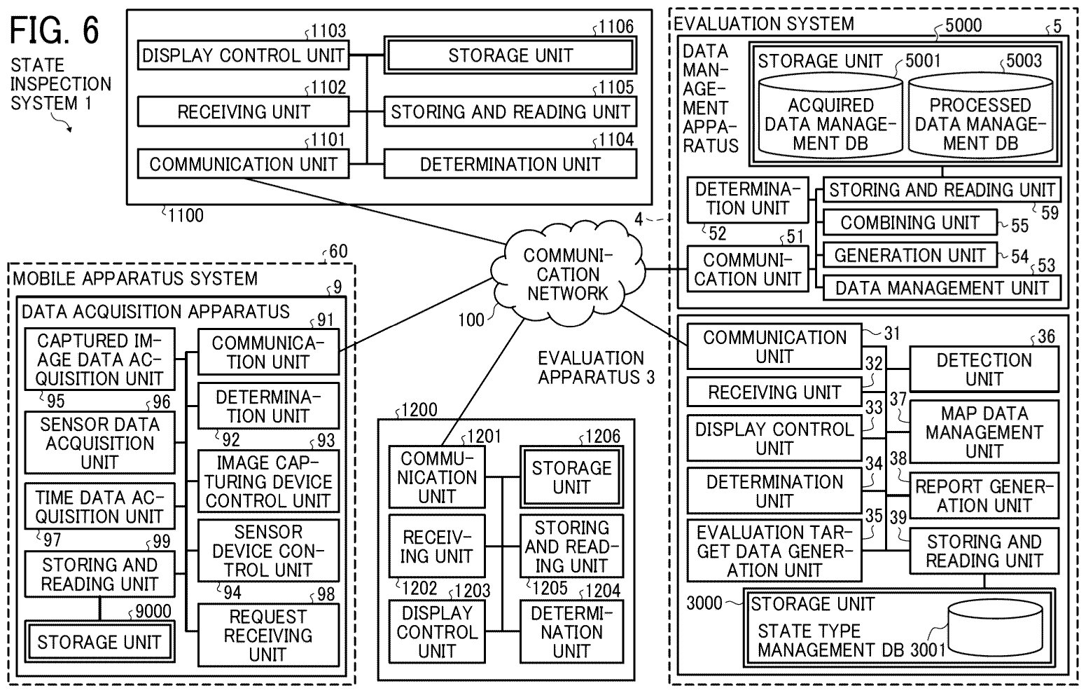

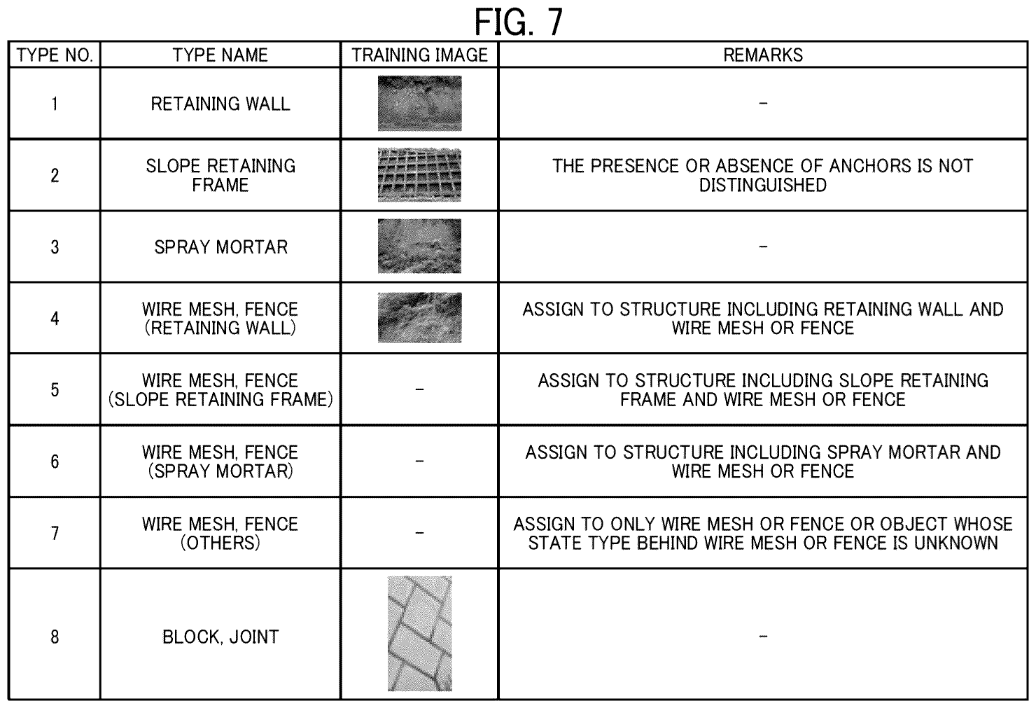

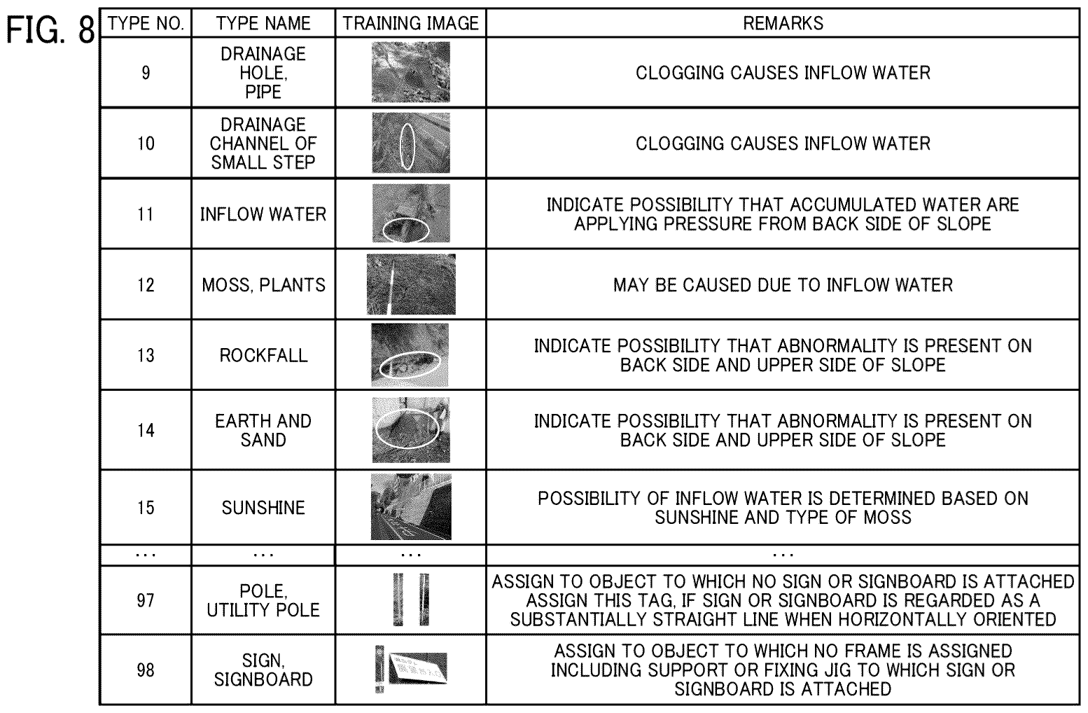

FIG. 7 and FIG. 8 are illustrations of an example of a state type management table. The state type management table is a table for managing training data for detecting a state type of a slope. The storage unit 3000 stores a state type management DB 3001 including the state type management table illustrated in FIGS. 7 and 8. The state type management table stores, for each type number, a type name indicating a state type, a training image, and remarks in association with one another.

The type name is a name indicating a state type for identifying the state of a slope, a physical quantity around the slope, and site information. Examples of the state type include types of the slope itself including structures, such as a retaining wall, a slope retaining frame, spray mortar, a wire mesh, a fence, a drainage hole, a pipe, and a drainage channel of a small step. Examples of the state type further include types indicating physical quantities around the slope, such as inflow water, moss, plants, rockfall, earth and sand, and sunshine. Further examples of the state type include, as the site information that supports the mobile apparatus system 60 in data acquisition, types such as a pole, a utility pole, a sign, and a signboard. Other examples of the state type may include, as supplementary information on a structure, landmark information such as a mark made with chalk indicating the presence of a defect, an artificial object such as a measurement device or a trace of countermeasure. Such supplementary information was provided at a past inspection or construction. The training image is an example of the training data. The training image is used for machine learning for determining the state type of a slope, a physical quantity around the slope, and site information based on captured-image data. The training data is not limited to a brightness image or a red, green, or blue (RGB) image, which is generally referred to as an image. In one example, the training data may be depth information, text, or voice, provided that the training data contains information based on which the state type is identified. In the remarks, information as a detection criterion for detecting the state type is described.

### Acquired Data Management Table

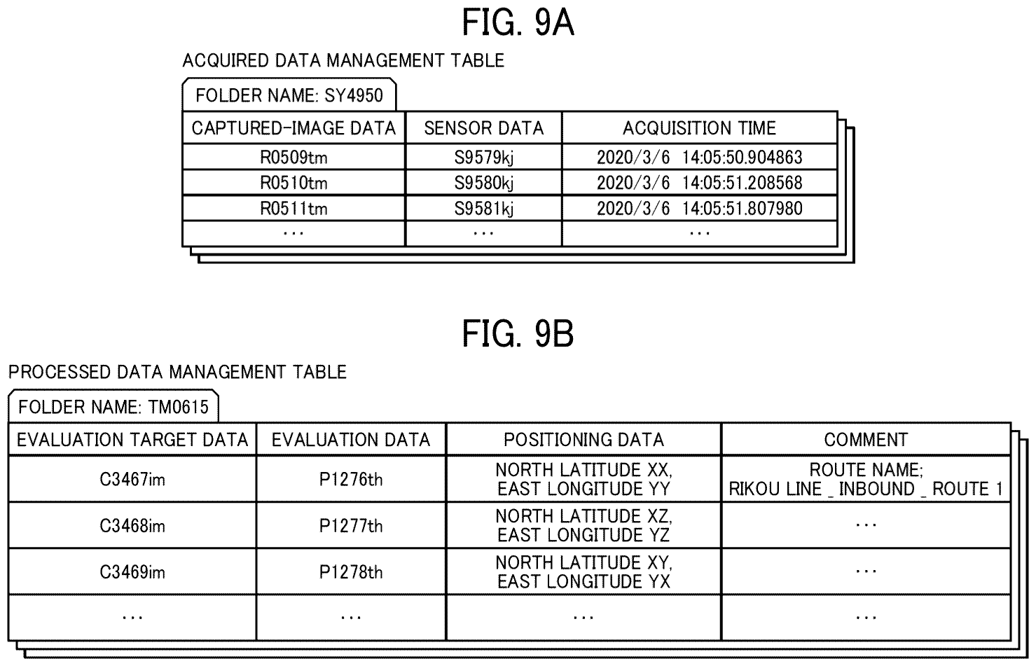

FIG. 9A is an illustration of an example of an acquired data management table. The acquired data management table is a table for managing various types of acquired data acquired by the data acquisition apparatus 9. The storage unit 5000 stores the acquired data management DB 5001. The acquired data management DB 5001 includes the acquired data management table illustrated in FIG. 9A. The acquired data management table stores, for each of folders, captured-image data, sensor data, and an acquisition time in association with one another.

The captured-image data and the sensor data are data files of acquired data transmitted from the data acquisition apparatus 9. The acquisition time indicates a time at which the captured-image data and the sensor data are acquired by the data acquisition apparatus 9. Data acquired in one inspection process is stored in the same folder. The sensor data includes three-dimensional sensor data. The captured-image data and the three-dimensional sensor data included in the sensor data are stored in association with coordinates. The captured-image data and the three-dimensional sensor data included in the sensor data are stored in association with positioning data. The positioning data is included in the sensor data. With this configuration, in response to selection of a desired location in the map information managed by the map data management unit 37 of the evaluation apparatus 3, the captured-image data and the three-dimensional sensor data at the selected location are read from the acquired data management DB 5001.

### Processed Data Management Table

FIG. 9B is an illustration of an example of a processed data management table. The processed data management table is a table for managing various types of processed data processed by the evaluation apparatus 3. The storage unit 5000 stores the processed data management DB 5003. The processed data management DB 5003 includes the processed data management table illustrated in FIG. 9B. The processed data management table stores, for each of folders, evaluation target data, evaluation data, positioning data, and a comment in association with one another.

The evaluation target data is a data file used for detection and evaluation of the state of a slope by the evaluation apparatus 3. The evaluation data is a data file indicating an evaluation result obtained by the evaluation apparatus 3. The positioning data is data indicating location information measured by the GNSS sensor 8b. The comment is an example of attribute information input by an evaluator who performs an evaluation for the evaluation target data or the evaluation data. With this configuration, in response to selection of a desired location in the map information managed by the map data management unit 37 of the evaluation apparatus 3, the evaluation data at the selected location is read from the processed data management DB 5003.

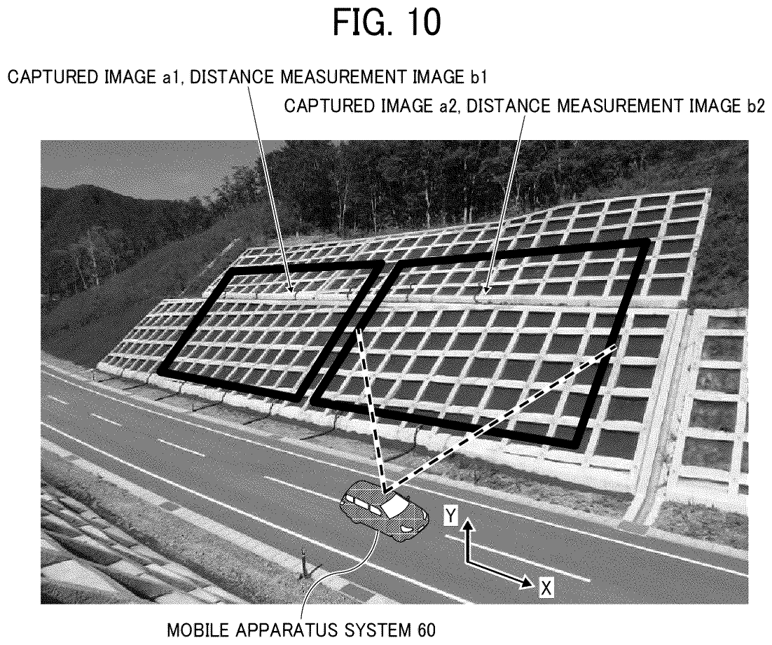

FIG. 10 is an illustration describing a captured image acquired by the mobile apparatus system 60.

The mobile apparatus system 60 captures an image of a slope on a road by using the image capturing device 7 of the data acquisition apparatus 9 while causing the mobile apparatus 6 to travel. In FIG. 10, an X-axis direction indicates the direction of movement of the mobile apparatus 6, and a Y-axis direction indicates the direction opposite of the direction of gravity. A Z-axis direction is orthogonal to the X-axis direction and the Y-axis direction and indicates a depth direction toward the slope from the mobile apparatus 6.

As illustrated in FIG. 10, as the mobile apparatus 6 travels, the data acquisition apparatus 9 acquires a captured image a1, a distance measurement image b1, a captured image a2, and a distance measurement image b2 in a chronological order. The distance measurement image b1 and the distance measurement image b2 are images acquired by the distance sensor 8a. The operation of the image capturing device 7 and the operation of the sensor device 8 are synchronized in time with each other. The captured image a1 and the distance measurement image b1 are images for a certain area of the slope, and the captured image a2 and the distance measurement image b2 are images of another certain area of the slope. Further, the captured images a1 and a2 are subjected to tilt correction (image correction) based on the positions of the vehicle serving as the mobile apparatus 6 at the time when the captured image a1 is obtained and the time when the captured image a2 is obtained, respectively. The time at which each of the captured images a1 and a2 is obtained is used to associate the image data and the positioning data (north latitude and east longitude) with each other.

As described above, the mobile apparatus system 60 acquires captured-image data representing an image of the slope and sensor data acquired when the image is captured by the image capturing device 7 while causing the vehicle serving as the mobile apparatus 6 to travel. The mobile apparatus system 60 uploads the acquired captured-image data and sensor data to the data management apparatus 5.

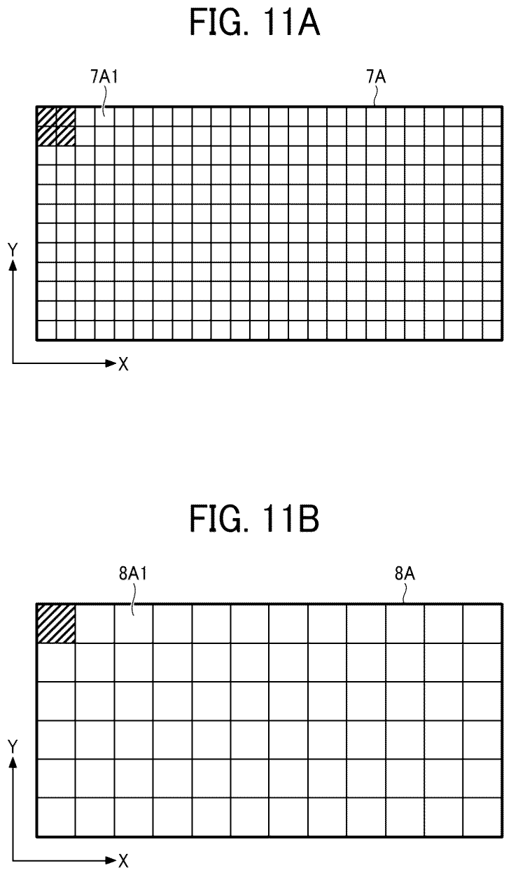

FIG. 11A and FIG. 11B are illustrations describing a captured image and a distance measurement image, respectively.

FIG. 11A illustrates captured-image data 7A such as captured-image data of the captured image a1 or the captured image a2 illustrated in FIG. 10. The captured-image data 7A is acquired by the image capturing device 7, and pixels 7A1 of the captured-image data 7A are arranged in locations indicated by coordinates in the X-axis direction and the Y-axis direction illustrated in FIG. 10. Each of the pixels 7A1 includes brightness information corresponding to an amount of stored electricity.

The brightness information of each of the pixels 7A1 of the captured-image data 7A is stored in the storage unit 5000 as the captured-image data illustrated in FIG. 9A in association with the corresponding coordinates in the X-axis direction and the Y-axis direction illustrated in FIG. 10.

FIG. 11B illustrates distance measurement image data 8A such as distance measurement image data of the distance measurement image b1 or the distance measurement image b2 illustrated in FIG. 10. The distance measurement image data 8A is acquired by the distance sensor 8a, and pixels 8A1 of the distance measurement image data 8A are arranged in locations indicated by coordinates in the X-axis direction and the Y-axis direction illustrated in FIG. 10. Each of the pixels 8A1 includes distance information in the Z-axis direction illustrated in FIG. 10. The distance information corresponds to an amount of stored electricity. The distance measurement image data 8A is three-dimensional point cloud data. The three-dimensional point cloud data is referred to as “distance measurement image data”, since in typical cases, the three-dimensional point cloud data is displayed in a visually recognizable manner such that the brightness information is added to the three-dimensional point cloud data to make the three-dimensional point cloud data visually perceptible to a user. In the following description, the captured-image data 7A and the distance measurement image data 8A are collectively referred to as “image data”.

The distance information of each of the pixels 8A1 of the distance measurement image data 8A is stored in the storage unit 5000 as three-dimensional data included in the sensor data illustrated in FIG. 9A in association with the corresponding coordinates in the X-axis direction and the Y-axis direction illustrated in FIG. 10.

Since the captured-image data 7A illustrated in FIG. 11A and the distance measurement image data 8A illustrated in FIG. 11B are images of the same area of the slope, the brightness information and the distance information are stored in the storage unit 5000 in association with the corresponding coordinates in the X-axis direction and the Y-axis direction illustrated in FIG. 10.

### Example Processing or Operation According to Embodiment

### Example Data Acquisition Processing

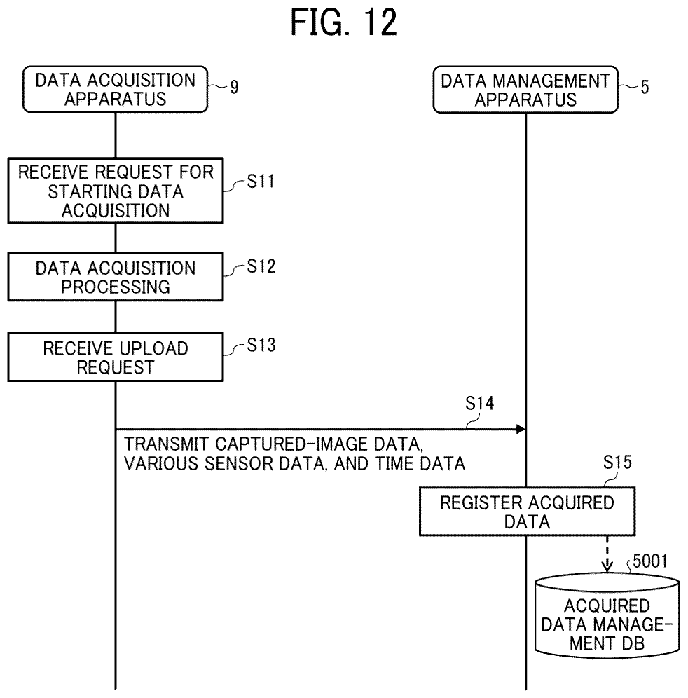

Processing or operation of the state inspection system 1 according to an embodiment will be described with reference to FIGS. 12 to 20. First, data acquisition processing using the mobile apparatus system 60 will be described with reference to FIG. 12. An inspection technician in charge of inspection of the state of a slope on a road captures images of the slope while being on board the mobile apparatus 6, and uploads acquired data to the data management apparatus 5. The details will be described hereinafter.

FIG. 12 is a sequence chart illustrating an example of the data acquisition processing using the mobile apparatus system 60. First, in response to, for example, the inspection technician performing a predetermined input operation on the external PC 930, the request receiving unit 98 of the data acquisition apparatus 9 receives a request for starting data acquisition (step S11). The data acquisition apparatus 9 performs data acquisition processing using the image capturing device 7 and the sensor device 8 (step S12). Specifically, the image capturing device control unit 93 sends an image capturing request to the image capturing device 7 to start image capturing processing for a predetermined area. Further, the sensor device control unit 94 controls the distance sensor 8a and the GNSS sensor 8b to start detection processing in synchronization with the image capturing processing performed by the image capturing device 7. The captured image data acquisition unit 95 acquires captured-image data obtained by the image capturing device 7. The sensor data acquisition unit 96 acquires sensor data obtained by the distance sensor 8a and the GNSS sensor 8b. The time data acquisition unit 97 acquires time data indicating times at which various types of data are acquired by the captured image data acquisition unit 95 and the sensor data acquisition unit 96.

Then, in response to, for example, the inspection technician performing a predetermined input operation on the external PC 930, the request receiving unit 98 receives a request for uploading the acquired various types of data (upload request) (step S13). The communication unit 91 uploads (transmits) the captured-image data, the sensor data, and the time data, which are acquired data acquired in step S12, to the data management apparatus 5 (step S14). Thus, the communication unit 51 of the data management apparatus 5 receives the acquired data transmitted from the data acquisition apparatus 9. The data management unit 53 of the data management apparatus 5 registers the acquired data received in step S14 in the acquired data management DB 5001 (see FIG. 9A) (step S15). The data management unit 53 stores the captured-image data and the sensor data in one folder in association with the time data indicating the times at which the items of data included in the acquired data are acquired.

### Example Processing for Evaluating State of Slope

### Generation of Evaluation Target Data

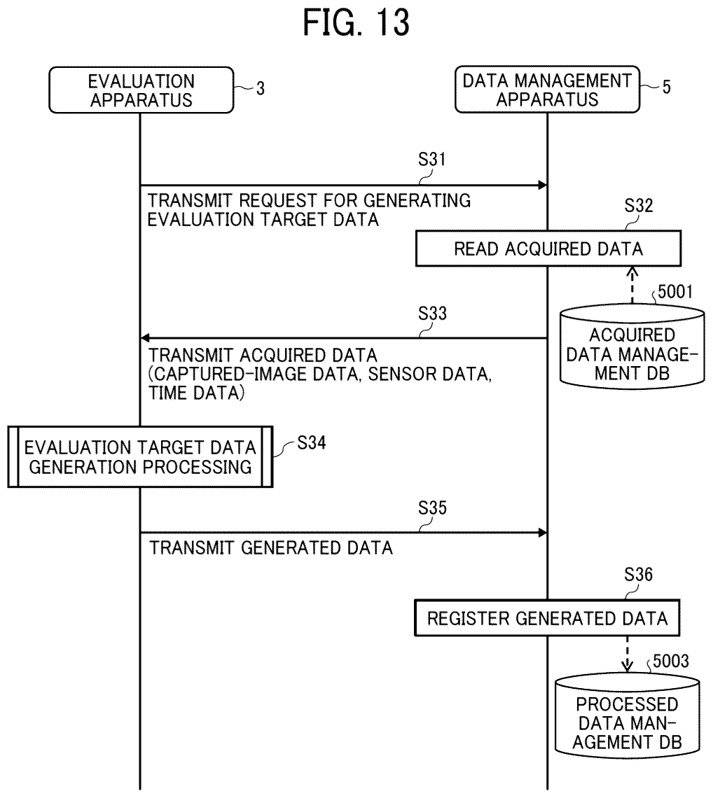

Next, processing for evaluating, by the evaluation system 4, the state of the slope by using the acquired data stored in the data management apparatus 5 will be described with reference to FIG. 13. First, a process for generating evaluation target data to be used for the processing for evaluating the state of the slope will be described with reference to FIG. 13. FIG. 13 is a sequence chart illustrating an example process for generating evaluation target data.

The communication unit 31 of the evaluation apparatus 3 transmits a request for generating evaluation target data to the data management apparatus 5 (step S31). The request includes a folder name indicating the name of a folder in which data to be generated is stored. Thus, the communication unit 51 of the data management apparatus 5 receives the request transmitted from the evaluation apparatus 3.

Then, the storing and reading unit 59 of the data management apparatus 5 searches the acquired data management DB 5001 by using the folder name included in the request received in step S31 as a search key to read acquired data associated with the folder name included in the request (step S32). The communication unit 51 transmits the acquired data read in step S32 to the evaluation apparatus 3 (step S33). The acquired data includes captured-image data, sensor data, and time data. Thus, the communication unit 31 of the evaluation apparatus 3 receives the acquired data transmitted from the data management apparatus 5.

Then, the evaluation target data generation unit 35 of the evaluation apparatus 3 generates evaluation target data by using the acquired data received in step S33 (step S34). Specifically, the evaluation target data generation unit 35 performs tilt correction on the captured-image data, based on the position of the image capturing device 7 (the mobile apparatus 6) at the time when the image corresponding to the captured-image data is captured, in accordance with the received sensor data obtained by the distance sensor 8a. Further, the evaluation target data generation unit 35 associates the captured-image data with positioning data, which is the received sensor data obtained by the GNSS sensor 8b, based on the received time data. Further, the evaluation target data generation unit 35 performs processing to combine a plurality of items of captured-image data into one item of image data.

As described above, the evaluation target data generation unit 35 has a function for performing tilt correction on image data, a function for associating image data with location information, and a function for combining items of image data. The evaluation target data generation unit 35 performs image correction on the received captured-image data by using the acquired data received from the data management apparatus 5 to facilitate processing by the detection unit 36 and the report generation unit 38 described below.

Then, the communication unit 31 of the evaluation apparatus 3 transmits the generated data generated in step S34 to the data management apparatus 5 (step S35). The generated data includes the evaluation target data generated by the evaluation target data generation unit 35, the positioning data, and the comment. Thus, the communication unit 51 of the data management apparatus 5 receives the generated data transmitted from the evaluation apparatus 3. The data management unit 53 of the data management apparatus 5 stores the generated data received in step S35 in the processed data management DB 5003 (see FIG. 9B) (step S36). Specifically, the data management unit 53 stores the evaluation target data, the positioning data, and the comment included in the generated data in one folder in association with each other.

As described above, the evaluation system 4 performs image processing based on various types of data acquired from the data acquisition apparatus 9, including captured-image data, sensor data, and time data, to generate evaluation target data to be used for the evaluation of the state of a slope.

### Generation of Evaluation Report

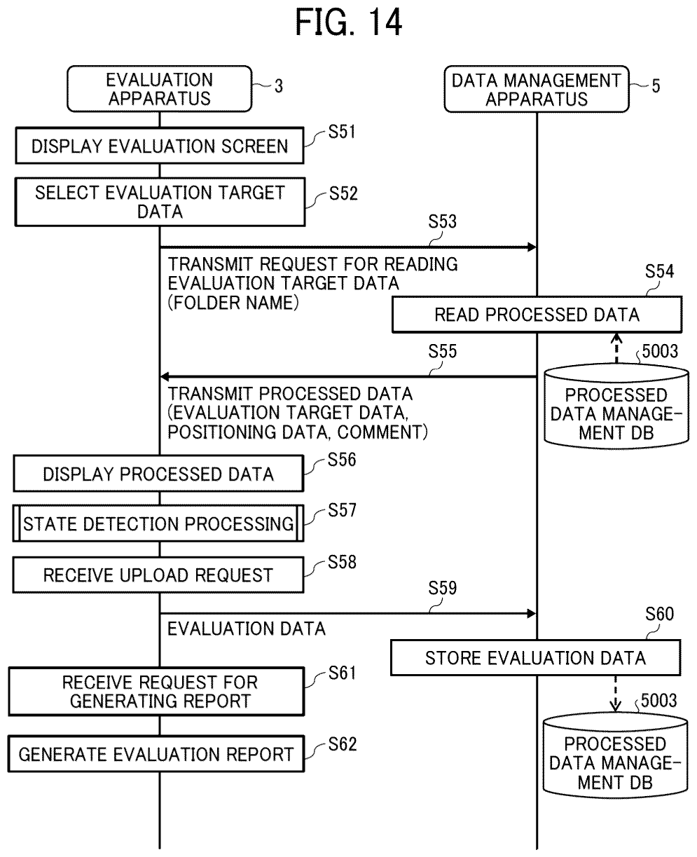

Next, a process for generating, in the evaluation system 4, an evaluation report to be submitted to the entity that manages roads will be described with reference to FIG. 14. An evaluator evaluates the state of the slope by using the data acquired by the data acquisition apparatus 9, such as the captured-image data and the sensor data, and generates an evaluation report indicating the evaluation result. The details will be described hereinafter.

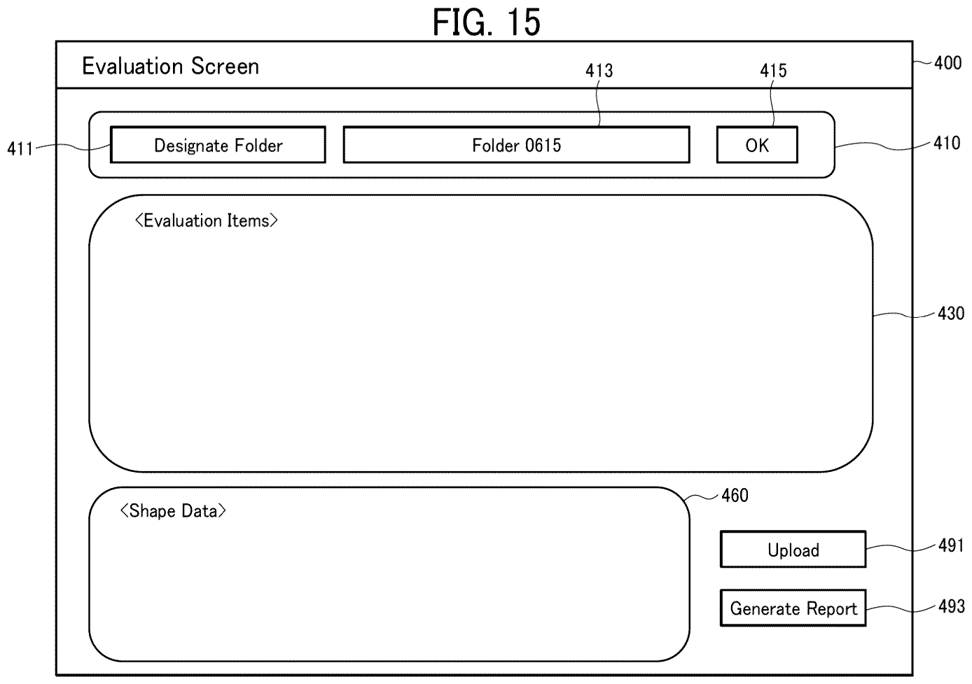

FIG. 14 is a sequence chart illustrating an example process for generating a report as a result of evaluation of the state of the slope. The display control unit 33 of the evaluation apparatus 3 causes the display 306 to display an evaluation screen 400 for performing processing of evaluating the state of the slope (step S51). FIG. 15 is a view illustrating an example of the evaluation screen 400 displayed on the evaluation apparatus 3. The evaluation screen 400 illustrated in FIG. 15 includes a selection area 410 for selecting evaluation target data, an evaluation item selection area 430 for selecting an evaluation item to detect the state of the slope, and a shape-data display area 460 for displaying shape data. The evaluation screen 400 further includes an “Upload” button 491 and a “Generate Report” button 493. The “Upload” button 491 is pressed to upload the evaluation result to the data management apparatus 5. The “Generate Report” button 493 is pressed to generate an evaluation report. The selection area 410 includes a “Designate Folder” button 411 for designating a folder in which the evaluation target data is stored, a display area 413 for displaying the name of the designated folder, and an “OK” button 415. The “OK” button 415 is pressed to request a download of the evaluation target data stored in the designated folder.

In FIG. 14, in response to the evaluator designating a folder by using the “Designate Folder” button 411, the receiving unit 32 of the evaluation apparatus 3 receives selection of evaluation target data (step S52). For example, in the example illustrated in FIG. 15, the receiving unit 32 receives selection of the evaluation target data stored in “folder 0615”.

Then, the communication unit 31 transmits a request for reading the evaluation target data selected in step S52 to the data management apparatus 5 (step S53). The request includes a folder name indicating the name of the folder selected in step S52. Thus, the communication unit 51 of the data management apparatus 5 receives the request transmitted from the evaluation apparatus 3.

Then, the storing and reading unit 59 of the data management apparatus 5 searches the processed data management DB 5003 (see FIG. 9B) by using the folder name included in the request received in step S53 as a search key to read processed data associated with the folder name included in the request (step S54). The communication unit 51 transmits the processed data read in step S54 to the evaluation apparatus 3 (step S55). The processed data includes the evaluation target data, the positioning data, and the comment. Thus, the communication unit 31 of the evaluation apparatus 3 receives the processed data transmitted from the data management apparatus 5.

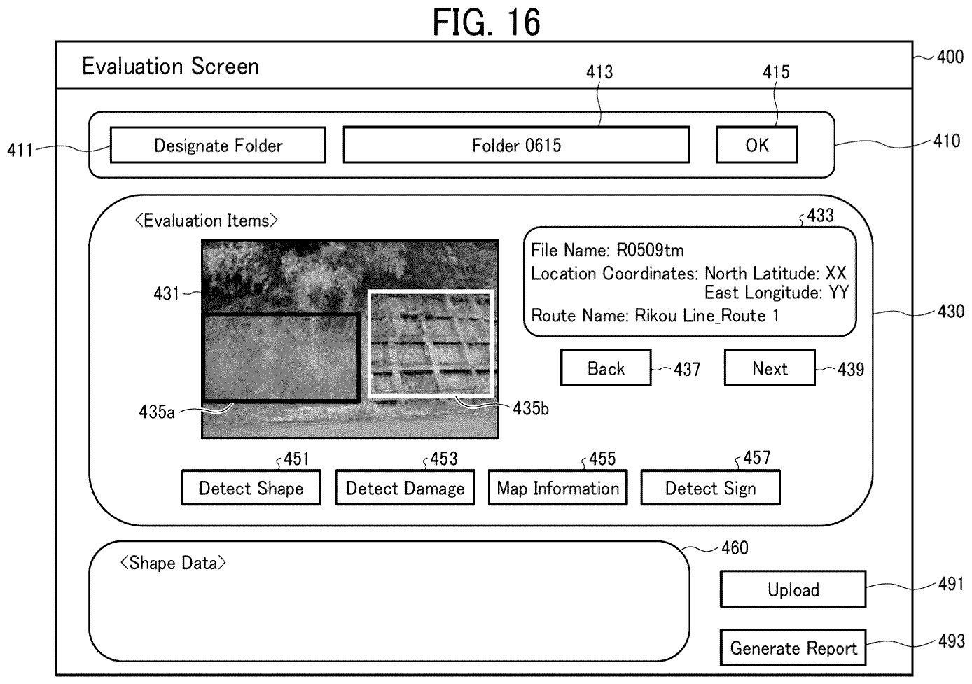

The display control unit 33 of the evaluation apparatus 3 displays the processed data, which is received in step S55, in the evaluation item selection area 430 on the evaluation screen 400 (step S56). FIG. 16 is a view illustrating an example of the evaluation screen 400 on which the processed data is displayed. The evaluation item selection area 430 illustrated in FIG. 16 includes an image display area 431 for displaying an image of evaluation target data, which is processed data transmitted from the data management apparatus 5, and an attribute information display area 433 for displaying attribute information of the evaluation target data. The evaluation item selection area 430 further includes a “Back” button 437 and a “Next” button 439. The “Back” button 437 and the “Next” button 439 are pressed to switch the image to be displayed in the image display area 431. The evaluation item selection area 430 further includes a “Detect Shape” button 451, a “Detect Damage” button 453, a “Map Information” button 455, and a “Detect Sign” button 457. The “Detect Shape” button 451 is pressed to detect the shape of the slope. The “Detect Damage” button 453 is pressed to detect the state of damage to the slope. The “Map Information” button 455 is pressed to generate map information. The “Detect Sign” button 457 is pressed to detect a sign of damage to the slope.

In the image display area 431, evaluation areas 435a and 435b are displayed in a manner superimposed on the image of the evaluation target data. The evaluation areas 435a and 435b indicate evaluation ranges in processing for detecting the state of the slope described below. The evaluator performs an input operation such as a tap, a drag, a swipe, a pinch-in, or a pinch-out on the evaluation areas 435a and 435b to move the evaluation areas 435a and 435b and enlarge or shrink the evaluation areas 435a and 435b. The evaluation areas 435a and 435b are an example, and one evaluation area or three or more evaluation areas may be used. In another example, the evaluation areas 435a and 435b are not displayed in the image display area 431, and the entire image display area 431 is used as an evaluation range.

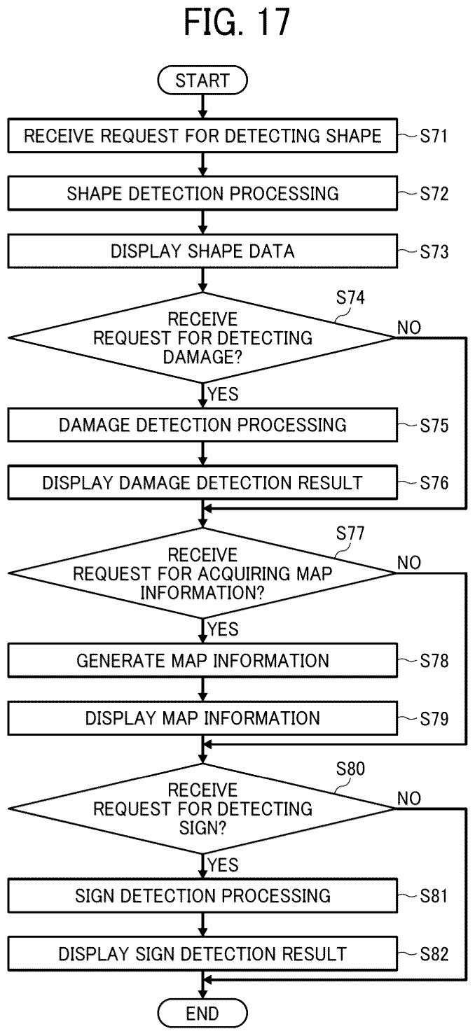

In FIG. 14, the evaluation apparatus 3 performs processing for detecting the state of the slope by using the evaluation target data (step S57). The processing for detecting the state of the slope will be described in detail with reference to FIG. 17. FIG. 17 is a flowchart illustrating an example of the processing for detecting the state of the slope.

First, in response to the evaluator pressing the “Detect Shape” button 451 in the evaluation item selection area 430, the receiving unit 32 receives a request for detecting the shape of the slope (step S71). Then, the detection unit 36 performs shape detection processing using the evaluation target data (step S72). In one example, shape data indicating the shape of the slope is represented by three-dimensional information such as an extension, a height, and an inclination angle of the slope, and location information. The extension of the slope is represented by, for example, a length of the slope in a plan view, such as a length in a depth direction of a cross section based on which the inclination of the slope is recognizable. The shape data also includes information indicating the type of the slope, i.e., whether the slope is a natural slope or an earthwork structure. When the slope is an earthwork structure, the shape data includes information on the type of the earthwork structure. Examples of the type of the earthwork structure include, but are not limited to, a retaining wall, a slope retaining frame, spray mortar, the presence or absence of anchors, and an embankment.

Specifically, the detection unit 36 detects the extension, the height, and the inclination angle of the slope based on the image data and the three-dimensional data included in the evaluation target data. The detection unit 36 further detects the type of the slope in an image, which is the evaluation target data, by using the state type management DB 3001 (see FIGS. 7 and 8). In this case, the detection unit 36 performs image matching processing using the training images indicated in the state type management table to detect the type of the slope.

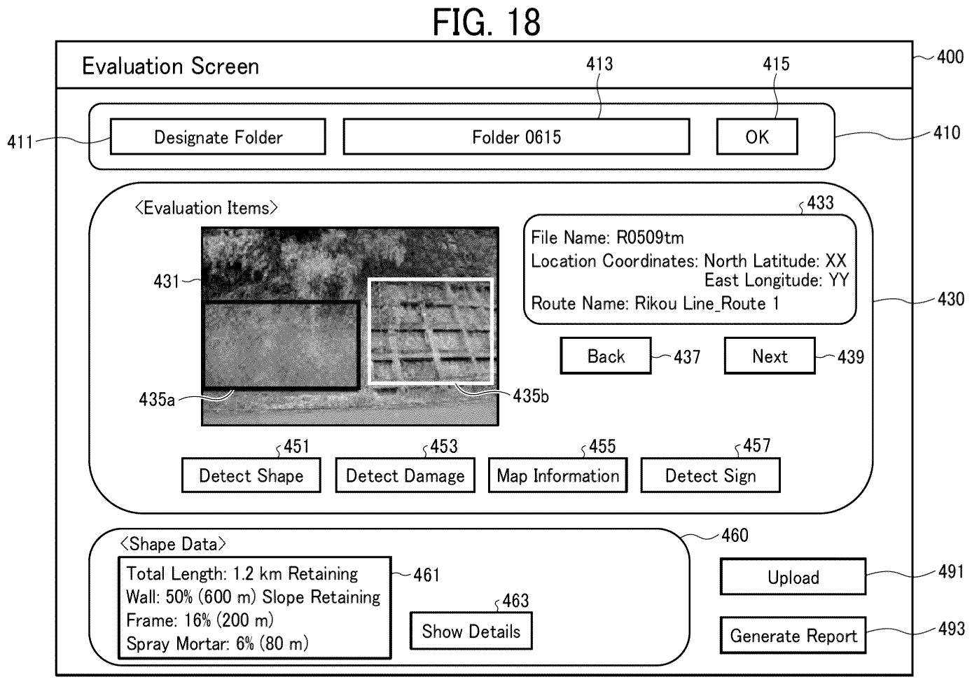

Then, the display control unit 33 displays the shape data, which is the detection result in step S72, in the shape-data display area 460 of the evaluation screen 400 (step S73). FIG. 18 is a view illustrating an example of the evaluation screen 400 on which the shape data indicating the detection result is displayed. The shape-data display area 460 illustrated in FIG. 18 includes a display area 461 for displaying attribute items of the shape data indicating the shape detection result obtained by the detection unit 36, and a “Show Details” button 463. The “Show Details” button 463 is pressed to display detailed data of the shape detection result. The display area 461 displays, for example, the total length of the slope and the proportions of the types of structures detected in the entire slope.

In steps S71 to S73 illustrated in FIG. 17 described above, processing for “structure information detection” may be performed instead of the processing for “shape detection”.

In this case, in response to the evaluator pressing a “Detect Structure Information” button in place of the “Detect Shape” button 451 in the evaluation item selection area 430, the receiving unit 32 receives a request for detecting structure information (step S71). Then, the detection unit 36 performs structure information detection processing using the evaluation target data (step S72). The display control unit 33 displays the structure information, which is the detection result in step S72, in a structure-information display area in place of the shape-data display area 460 of the evaluation screen 400 (step S73).

In one example, the structure information includes supplementary information of a structure in addition to the shape data described above. Specifically, the detection unit 36 detects the type of the slope in an image, which is the evaluation target data, and the type of the supplementary information of the slope by using the state type management DB 3001 (see FIGS. 7 and 8), based on the image data and the three-dimensional data included in the evaluation target data. In this case, the detection unit 36 performs image matching processing using the training images indicated in the state type management table to detect the type of the slope and the supplementary information of the slope.

In FIG. 17, if the receiving unit 32 receives a request for detecting damage to the slope (damage detection request) in response to the evaluator pressing the “Detect Damage” button 453 in the evaluation item selection area 430 (YES in step S74), the operation proceeds to step S75. If the receiving unit 32 receives no damage detection request (NO in step S74), the operation proceeds to step S77. The detection unit 36 performs damage detection processing on the evaluation target data to detect damage to the slope (step S75).

In the damage detection processing, in one example, the presence or absence of a defect in the slope or the degree of the defect is detected as damage data indicating the degree of damage to the slope. The degree of the defect indicates the degree of deterioration of the defect, such as a width of a crack, a size of a separation, or a size of a floating. The detection unit 36 detects the presence or absence of a defect in the slope or the degree of the defect based on the image data and the sensor data included in the evaluation target data. Further, the detection unit 36 determines whether the degree of the defect exceeds a predetermined value by using, for example, a detection equation that is set in advance for obtaining the degree of deterioration of the defect. In this case, the detection unit 36 determines, for example, whether the width of a crack is equal to or greater than a certain value, whether the size of a separation is equal to or greater than a certain value, or whether a floating is large.

Referring back to FIG. 13, in step S36, the data management unit 53 of the data management apparatus 5 stores the coordinates of the location of a damaged portion and the type of damage in the processed data management DB 5003 in association with the corresponding coordinates in the X-axis direction and the Y-axis direction in the captured-image data 7A illustrated in FIG. 11A.

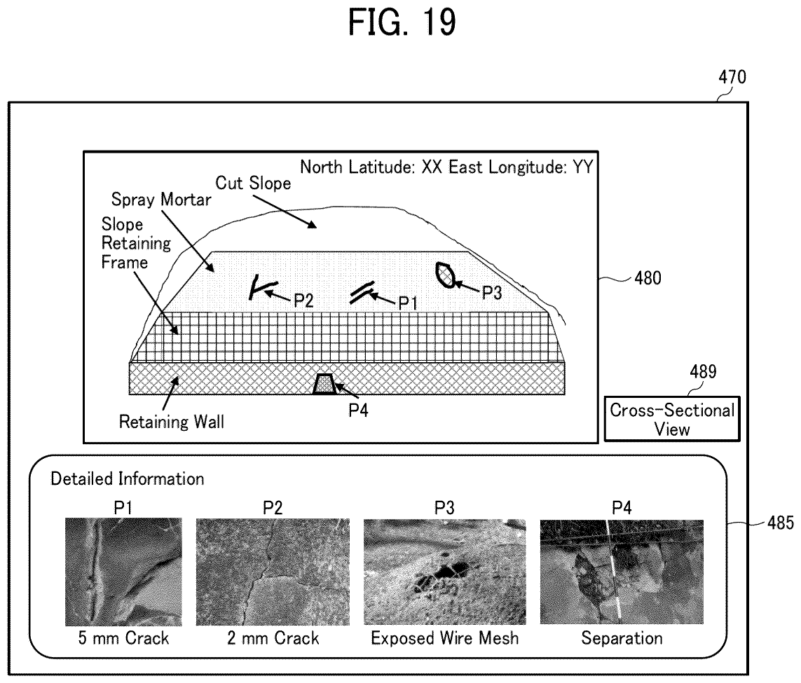

In FIG. 17, the display control unit 33 causes the display 306 to display a display screen 470 indicating the damage detection result in step S75 (step S76). FIG. 19 is a view illustrating an example of the display screen 470 indicating the damage detection result. The display screen 470 illustrated in FIG. 19 includes a display image area 480, a detailed-information display area 485, and a “Cross-Sectional View” button 489. In the display image area 480, the locations of damaged portions detected in the entire slope to be evaluated are displayed. In the detailed-information display area 485, captured images corresponding to the locations of the detected damaged portions are displayed. The “Cross-Sectional View” button 489 is pressed to display a cross-sectional view of the detected slope. The display image area 480 displays a plan view in which images (P1 to P4) indicating the locations of the detected damaged portions are drawn on an image indicating the two-dimensional shape of the slope to be evaluated. The display image area 480 also displays position coordinates (positioning data) indicating the location of the slope to be evaluated.

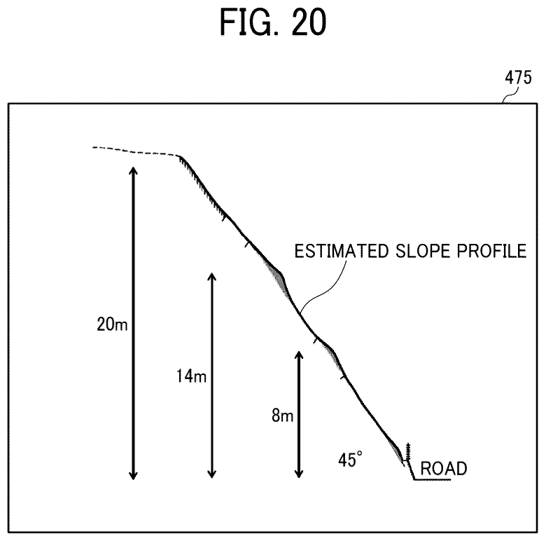

In response to the evaluator pressing the “Cross-Sectional View” button 489, the display control unit 33 causes the display 306 to display a cross-sectional image 475 illustrated in FIG. 20. The cross-sectional image 475 represents a cross-sectional view of the slope to be evaluated. The cross-sectional view is drawn based on the shape data detected by the detection unit 36. The shape data is detected by using the sensor data obtained by the distance sensor 8a (three-dimensional sensor). Thus, the cross-sectional image 475 can represent details of the slope, including three-dimensional information, such as the inclination or height of the slope that is difficult to calculate in a two-dimensional image.

In FIG. 17, if the receiving unit 32 receives a request for acquiring map information (map information acquisition request) in response to the evaluator pressing the “Map Information” button 455 in the evaluation item selection area 430 (YES in step S77), the operation proceeds to step S78. If the receiving unit 32 receives no map information acquisition request (NO in step S77), the operation proceeds to step S80.

The detection unit 36 generates map information indicating the location of the slope to be evaluated (step S78). Specifically, the detection unit 36 adds an image indicating the location of the slope to the location (north latitude and east longitude) indicated by the positioning data acquired in step S55 to generate map information. The map information corresponds to map data available using a predetermined service or an application provided by, for example, an external web server. The map data provided from the external web server is managed by the map data management unit 37.

The display control unit 33 causes the display 306 to display the map information generated in step S78 (step S79).

If the receiving unit 32 receives a request for detecting a sign of damage to the slope (sign detection request) in response to the evaluator pressing the “Detect Sign” button 457 in the evaluation item selection area 430 (YES in step S80), the operation proceeds to step S81. If the receiving unit 32 receives no sign detection request (NO in step S80), the operation ends. The detection unit 36 performs sign detection processing on the evaluation target data to detect a sign of damage to the slope (step S81).

In the related art, in response to recognition of a defect in a slope, a state inspection system identifies the state of the defect and the location of the defect. In the related art, however, information indicating a sign of a defect that is likely to occur in the slope in a certain location is not measured before the defect occurs in the slope. In the sign detection processing for detecting a sign of damage to the slope, a sign of a defect in the slope is detected as sign data indicating a sign of damage to the slope, based on measurement data of the slope. The measurement data includes surrounding data indicating a physical quantity around the slope.

The measurement data includes captured-image data obtained by the image capturing device 7 capturing an image of the slope, or the sensor data obtained by a three-dimensional sensor such as the distance sensor 8a measuring the slope. In other words, the measurement data includes measurement data regarding the subject for inspection (in this example, the slope).

The surrounding data includes measurement data of an object other than the slope. The object other than the slope includes, for example, at least one of inflow water, earth and sand, rocks, and plants.

When the measurement data of the slope includes surrounding data indicating inflow water along the slope, accumulated water may be applying pressure from the back side of the slope. Thus, the presence of a sign of a defect in the slope is detected. Specifically, in the presence of inflow water, the presence of a sign of a defect in the slope is detected in accordance with an amount, a type, and a location of the inflow water.

When the measurement data of the slope includes surrounding data indicating plants and moss growing along the slope, inflow water may occur, and accumulated water may be applying pressure from the back side of the slope. Thus, the presence of a sign of a defect in the slope is detected. Specifically, in the presence of plants and moss, the presence of a sign of a defect in the slope is detected in accordance with an amount, a type, and a location of the plants and moss.

When the measurement data of the slope includes surrounding data indicating rockfall or earth and sand from the slope, an abnormality may be present on the back side and the upper side of the slope. Thus, the presence of a sign of a defect in the slope is detected. Specifically, in the presence of rockfall or earth and sand, the presence of a sign of a defect in the slope is detected in accordance with an amount, a type, and a location of the rockfall or earth and sand.

When the measurement data of the slope includes surrounding data indicating clogging of a drainage hole, a pipe, or a drainage channel of a small step, drainage from the back side to the front side of the slope may be prevented, and accumulated water may be applying pressure from the back side of the slope. Thus, the presence of a sign of a defect in the slope is detected. Specifically, in the presence of clogging, the presence of a sign of a defect in the slope is detected in accordance with an amount, a type, and a location of clogged foreign material.

Damage to a drainage hole, a pipe, or a drainage channel of a small step is detected as a defect in the slope. In contrast, clogging of a drainage hole, a pipe, or a drainage channel of a small step is detected as a sign of a defect in the slope, rather than as a defect in the slope.

Several items of measurement data of objects other than the slope have been described. A combination of multiple items of such measurement data may be used to detect a sign of a defect in the slope. Specifically, when the measurement data of the slope includes surrounding data indicating that inflow water is occurring only in a small part of the slope and when moss spreads over the entire surface of the slope, inflow water is likely to spread over the entire surface of the slope. Thus, the presence of a sign of a defect in the slope is detected.

The surrounding data includes measurement data of physical quantities other than those related to the object. The measurement data of physical quantities other than the object includes measurement data of light.

When the measurement data of the slope includes surrounding data indicating the degree of sunshine, such surrounding data is used for detection of the presence of a sign of a defect in the slope in combination with the measurement data of an object other than the slope. Specifically, in a case where moss grows in a sunny spot where the slope easily dries, there is a possibility that inflow water is occurring, and accumulated water is applying pressure from the back side of the slope. Thus, the presence of the sign of a defect in the slope is detected.

Through the sign detection processing for detecting a sign of damage to the slope, a comment on a sign of a defect in the slope is generated, as the sign data indicating a sign of damage to the slope, based on the measurement data including the measurement data of the slope and the surrounding data indicating the physical quantity around the slope. Referring back to FIG. 13, in step S36, the data management unit 53 of the data management apparatus 5 stores, in the processed data management DB 5003, coordinates of the location indicated by the sign of the defect and the comment in association with the corresponding coordinates in the X-axis direction and the Y-axis direction in the captured-image data 7A illustrated in FIG. 11A.

Specifically, the training images in the state type management table illustrated in FIG. 8 are referred to, based on the captured-image data, which is an example of the acquired surrounding data, to generate a comment indicating the type, the amount, and the position of the physical quantity around the slope such as inflow water. For example, a comment “moss rate 30%, growing mostly in the vicinity of a height of 3 to 20 m of the starting point” is generated.

In FIG. 19, the display control unit 33 causes the display 306 to display a display screen 470 indicating the sign detection result in step S81 (step S82).

In response to the evaluator pressing a “Cross-Sectional View” button 489, the display control unit 33 causes the display 306 to display the cross-sectional image 475.

As described above, the evaluation system 4 evaluates the state of the slope and detects the shape of the slope including the three-dimensional information, the degree of damage to the slope, the sign of a defect in the slope, and the location of the slope to be evaluated.

Referring back to FIG. 14, in response to the evaluator pressing the “Upload” button 491 in the evaluation screen 400, the receiving unit 32 receives an upload request to update the evaluation result (step S58). The communication unit 31 uploads (transmits) the evaluation result to the data management apparatus 5 (step S59). Thus, the communication unit 51 of the data management apparatus 5 receives the evaluation data transmitted from the evaluation apparatus 3. The data management unit 53 of the data management apparatus 5 registers the evaluation data received in step S59 in the processed data management DB 5003 (see FIG. 9B) (step S60). In this case, the data management unit 53 stores the evaluation data in one folder in association with the evaluation target data on which the evaluation has been performed.

Further, in response to the evaluator pressing the “Generate Report” button 493 in the evaluation screen 400, the receiving unit 32 receives a request for generating an evaluation report (step S61). The report generation unit 38 generates an evaluation report based on the result of detecting the state of the slope by the detection unit 36 (step S62). The report generation unit 38 arranges the evaluation data indicating the evaluation result described above in accordance with an inspection guideline issued by, for example, the government, in a format requested by the entity that manages roads to generate an evaluation report.

As described above, the evaluation system 4 evaluates the state of the slope by using the captured-image data, the sensor data (three-dimensional data), and the positioning data acquired by the mobile apparatus system 60 to generate a report indicating the shape of the slope, the location of a damaged portion, and the degree of damage. As a result, the evaluation system 4 can improve the quality and efficiency of a report generation function provided as an image determination service or a slope shape or damage determination service used for slope inspection.

In the state detection processing performed by the detection unit 36, not all of the steps illustrated in FIG. 17 may be performed. In one example, at least the shape detection processing in steps S71 to S73 is performed. The evaluator performs, in addition to the shape detection processing, the damage detection processing in steps S74 to S76 and the map information generation processing in steps S77 to S79, if any, to generate an evaluation report including detailed evaluation results.

### Examples of First Image, Second Image, and Composite Image

Next, an example of the first image, an example of the second image, and an example of a composite image of the first image and the second image will be described with reference to FIGS. 21 to 25. FIG. 21 illustrates an example situation in which the mobile apparatus system 60 captures the first image and the second image. FIG. 21 is a schematic view of the mobile apparatus 6 moving in a direction of travel 61 on a road facing the slope 200, as viewed from above.

While moving with the mobile apparatus 6, the mobile apparatus system 60 acquires captured-image data of the first image and the second image by using the image capturing device 7 and acquires sensor data including a three-dimensional surface shape of the slope 200 by using the distance sensor 8a. The slope 200 has a mark 210 as a guide for capturing images. The mark 210 represents a desired area selected in the slope 200. In one example, the mark 210 include a stone or a sign present on the slope 200. In another example, the mark 210 may be any object that is recognizable when a captured image thereof is observed at a later date.

In the present embodiment, the mobile apparatus system 60 moves twice in the direction of travel 61 on the road facing the slope 200, and captures the first image in the first movement and the second image in the second movement. In the first movement, an image of the mark 210 on the slope 200 is captured at time T1 by the image capturing device 7 with an amount of exposure E1. In the second movement, an image of the mark 210 on the slope 200 is captured at time T2 by the image capturing device 7 with an amount of exposure E2. In the mobile apparatus system 60, the image capturing device 7 captures an image of the slope 200 while moving with the mobile apparatus 6. Thus, the relative position between the image capturing device 7 and the slope 200 is constantly changing.

The mobile apparatus system 60 acquires captured-image data of the first image and captured-image data of the second image such that an image area corresponding to the slope 200 in the first image and an image area corresponding to the slope 200 in the second image correspond to substantially the same area in the slope 200 in the real space and have substantially the same size. Accordingly, the combining unit 55 illustrated in FIG. 6 can easily combine the first image and the second image.

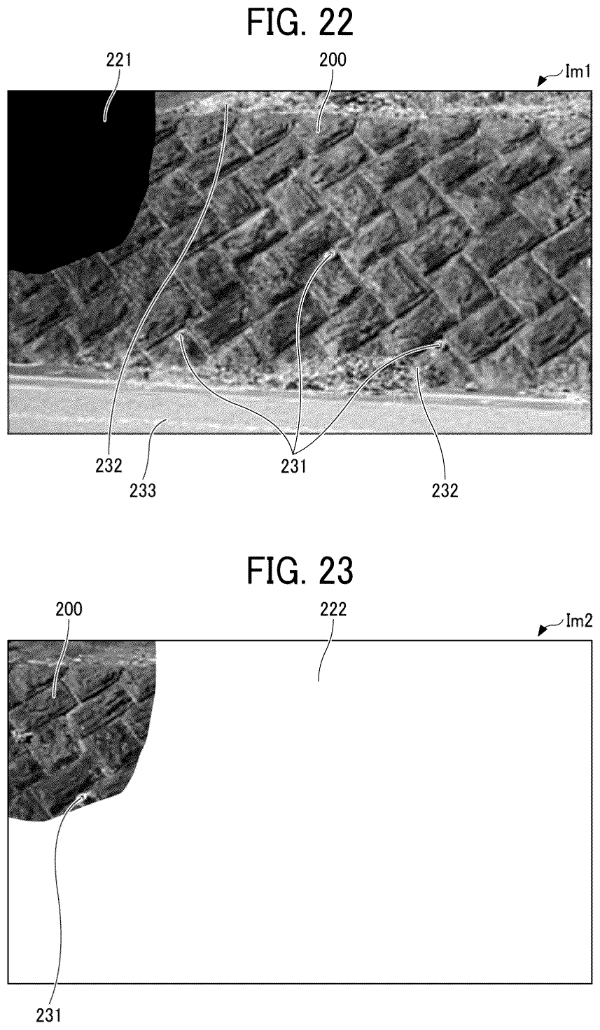

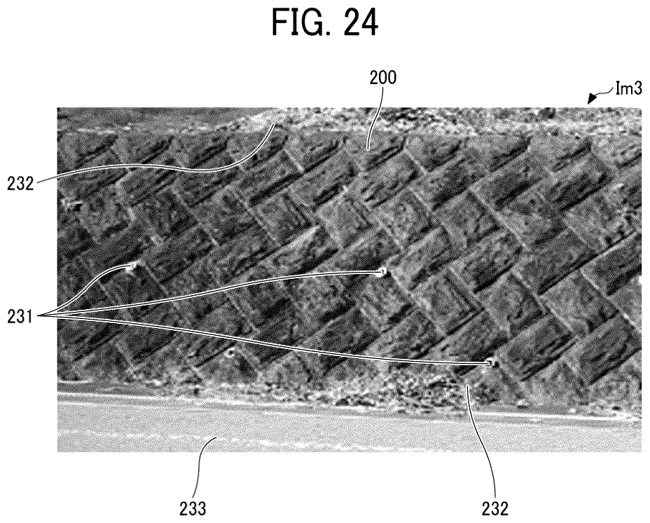

FIG. 22 is an illustration of an example of the first image according to the present embodiment. FIG. 23 is an illustration of an example of the second image according to the present embodiment. FIG. 24 is an illustration of an example of a composite image of the first image illustrated in FIG. 22 and the second image illustrated in FIG. 23. The slope 200 in the images illustrated in FIGS. 22 to 24 includes a retaining wall, by way of example.

In the example illustrated in FIGS. 22 and 23, the amount of exposure E2 and the amount of exposure E1 are different. For example, the image capturing device 7 performs an image capturing operation during the second movement, with the shutter speed set lower than that during the first movement or the aperture set larger than that during the first movement. As a result, the amount of exposure can be changed from the amount of exposure E1 to the amount of exposure E2. The amount of exposure may be adjusted by using any other method.

In FIG. 22, a first image Im1 is an image captured by the mobile apparatus system 60 at the amount of exposure E1 in the first movement. The first image Im1 includes an underexposed image area 221. The underexposed image area 221 is an image area having no difference in brightness of pixels due to underexposure. In one example, the underexposed image area 221 is a completely black image area. In the underexposed image area 221, detailed information on the state of the slope 200 is not obtained.

In FIG. 23, a second image Im2 is an image captured by the mobile apparatus system 60 at the amount of exposure E2 in the second movement. In the second image Im2, the amount of exposure E2 is larger than the amount of exposure E1, resulting in improvement in shadow detail in an image area corresponding to the underexposed image area 221 in the first image I1. As a result, the image area corresponding to the underexposed image area 221 in the first image I1 has differences in brightness of pixels. In contrast, the second image Im2 includes an overexposed image area 222 due to exposure settings in which the amount of exposure E2 is set larger than the amount of exposure E1. The overexposed image area 222 is an image area having no difference in brightness of pixels due to overexposure. In one example, the overexposed image area 222 is a completely white image area. In the overexposed image area 222, detailed information on the state of the slope 200 is not obtained.

In FIG. 24, a composite image Im3 is an image obtained by the combining unit 55 combining the first image Im1 and the second image Im2, which are captured by the image capturing device 7. The combining unit 55 combines an image area other than the underexposed image area 221 in the first image Im1 and an image area other than the overexposed image area 222 in the second image Im2 and acquires the composite image Im3. In one example, the underexposed image area 221 in the first image Im1 and the overexposed image area 222 in the second image Im2 do not have an exclusive relationship. The combining unit 55 can combine the first image Im1 and the second image Im2 such that the underexposed image area 221 in the first image Im1 is compensated for by the second image Im2 or the overexposed image area 222 in the second image Im2 is compensated for by the first image Im1.

As described above, in the present embodiment, a plurality of captured images with different amounts of exposure can be obtained in a state where the relative position between the image capturing device 7 and the object (e.g., the slope 200) is constantly changing at least in the direction of travel 61. In the present embodiment, in the state inspection system 1, the combining unit 55 acquires the composite image Im3 of the first image Im1 and the second image Im2. The state inspection system 1 can use the composite image Im3, in which blocked-up shadows and blown-out highlights are reduced, to reduce the number of image areas in which detailed information on the state of the slope 200 is difficult to obtain. As a result, the state inspection system 1 can inspect the slope 200 with high quality. For example, the state inspection system 1 can inspect the slope 200 without overlooking deterioration of the slope 200 due to aging.

In the present embodiment, the combining unit 55 may acquire the composite image Im3 based on corresponding feature points in the first image Im1 and the second image Im2, which are captured by the image capturing device 7. Examples of such a feature point include, in FIGS. 22 to 24, a plurality of drain holes 231 in the slope 200, boundaries 232 between the retaining wall and the vegetation on the slope 200, and a lane line 233 on the road. The combining unit 55 extracts, from the first image Im1 and the second image Im2, image areas corresponding to the same area in the slope 200 in the real space, by using the feature points described above in the first image Im1 and the second image Im2 as clues. The combining unit 55 can combine the first image Im1 and the second image Im2 such that the extracted image areas overlap.

In the present embodiment, the combining unit 55 may compare a plurality of cross-sectional images 475 (see FIG. 20) generated by the generation unit 54 illustrated in FIG. 6 to acquire the composite image Im3. For example, the combining unit 55 extracts a cross-sectional image substantially overlapping a cross-sectional image captured at the time T1 during the first movement from among a plurality of cross-sectional images captured during the second movement. The combining unit 55 can determine the time T2, at which an image of the mark 210 is captured during the second movement, from the time at which the extracted cross-sectional image is captured. As a result, the combining unit 55 can combine the first image Im1 and the second image Im2, which are captured at different times.

In the present embodiment, the combining unit 55 may compare a plurality of three-dimensional surface images generated by the generation unit 54 to acquire the composite image Im3. This combining method is a three-dimensional version of the combining method using cross-sectional images described above. In the combining method using cross-sectional images, a large amount of two-dimensional information related to the cross-sectional images is processed to determine the time T2, at which an image of the mark 210 illustrated in FIG. 21 is captured during the second movement. Such processing is performed by a computer with high processing capability. In a combining method using three-dimensional surface images, a time at which the difference in data between two three-dimensional surface images is small is selected using the three-dimensional surface images to determine the time T2, at which an image of the mark 210 illustrated in FIG. 21 is captured during the second movement. This combining method can efficiently determine the time T2, at which an image of the mark 210 illustrated in FIG. 21 is captured during the second movement, without using a computer having high computing capability.

In the present embodiment, the first image and the second image are captured by using one image capturing device 7. With this configuration, the power consumption of the image capturing device 7 can be reduced compared to when the first image and the second image are captured by using a plurality of image capturing devices.

### Second Embodiment

Next, a mobile apparatus system according to a second embodiment will be described. In the second embodiment, substantially the same elements as those in the first embodiment are denoted by the same reference numerals, and redundant descriptions thereof will be omitted. The same applies to other embodiments described below.

The present embodiment is mainly different from the first embodiment in that the first image and the second image are captured by using a plurality of image capturing devices while the relative position between each of the image capturing devices and the slope is constantly changing. In other words, the mobile apparatus system according to the present embodiment can capture the first image and the second image while moving once with a mobile apparatus.

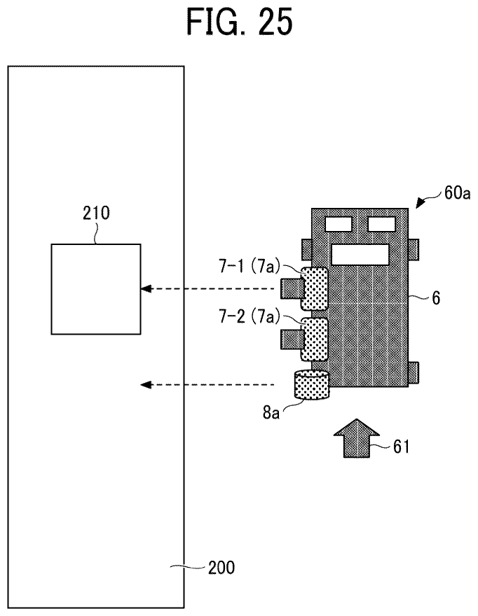

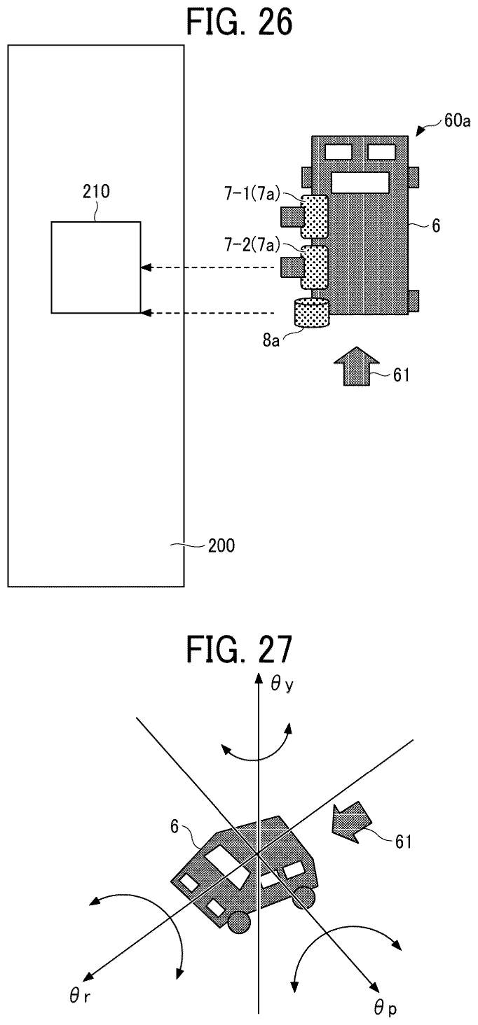

FIG. 25 illustrates an example situation in which a mobile apparatus system 60a according to the present embodiment captures the first image. FIG. 26 illustrates an example situation in which the mobile apparatus system 60a captures the second image. As illustrated in FIGS. 25 and 26, the mobile apparatus system 60a includes two image capturing devices 7a. The two image capturing devices 7a include a first image capturing device 7-1 and a second image capturing device 7-2. The first image capturing device 7-1 and the second image capturing device 7-2 have the same configuration and functions as those of the image capturing device 7 according to the first embodiment. In one example, the first image capturing device 7-1 and the second image capturing device 7-2 may have different configurations and functions from the image capturing device 7. The first image capturing device 7-1 and the second image capturing device 7-2 preferably have the same number of pixels.

FIGS. 25 and 26 are schematic views of the mobile apparatus 6 moving in the direction of travel 61 on the road facing the slope 200, as viewed from above. While moving with the mobile apparatus 6, the mobile apparatus system 60a can acquire captured-image data of the first image and the second image by using the first image capturing device 7-1 and the second image capturing device 7-2 and acquire sensor data including a three-dimensional surface shape of the slope 200 by using the distance sensor 8a.

In the present embodiment, while the mobile apparatus system 60a moves once in the direction of travel 61 on the road facing the slope 200, the first image capturing device 7-1 captures the first image, and the second image capturing device 7-2 captures the second image. The image capturing device 7-1 captures an image of the mark 210 on the slope 200 at time T1 with an amount of exposure E1. The image capturing device 7-2 captures an image of the mark 210 on the slope 200 at time T1+ΔT with an amount of exposure E2. A time difference ΔT is a difference between the time at which the first image capturing device 7-1 captures an image and the time at which the second image capturing device 7-2 captures an image.

Since the time difference ΔT is minute, the difference in distance from the mobile apparatus 6 to the slope 200 or the difference in the position of the mobile apparatus 6 between the time T1 and the time T1+ΔT is small. Accordingly, an image area corresponding to the slope 200 in the first image and an image area corresponding to the slope 200 in the second image correspond to substantially the same area in the slope 200 in the real space and have substantially the same size. In the present embodiment, therefore, it is possible to easily capture the first image and the second image such that the first image and the second image include respective image areas corresponding to substantially the same area in the slope 200 in the real space and having substantially the same size. As a result, the combining unit 55 illustrated in FIG. 6 can easily combine the first image and the second image.

In one example, the first image capturing device 7-1 and the second image capturing device 7-2 are not arranged side by side in the direction of travel 61, but the first image capturing device 7-1 and the second image capturing device 7-2 are arranged side by side in the direction of gravity. In this example, the first image capturing device 7-1 and the second image capturing device 7-2 may be set at different positions to allow the first image capturing device 7-1 and the second image capturing device 7-2 to capture images of substantially the same area in the slope 200 in the direction of gravity. Therefore, it is possible to easily capture the first image and the second image such that the first image and the second image include respective image areas corresponding to substantially the same area in the slope 200 in the real space and having substantially the same size. Thus, the combining unit 55 can easily combine the first image and the second image.

The other operations and effects of the present embodiment are substantially the same as those of the first embodiment.

### Third Embodiment

Next, a state inspection system according to a third embodiment will be described. The present embodiment is mainly different from the first embodiment in that the combining unit 55 changes the size of an image area corresponding to an object in at least one of the first image and the second image such that the image area corresponding to the object in the first image and the image area corresponding to the object in the second image have the same size.

FIG. 27 is an illustration of a position of the mobile apparatus 6. In FIG. 27, the mobile apparatus 6 has a roll angle θr, a pitch angle θp, and a yaw angle θy. The roll angle θr corresponds to the position (angle) of the mobile apparatus 6 about an axis extending in the direction of travel 61 of the mobile apparatus 6. The pitch angle θp corresponds to the position (angle) of the mobile apparatus 6 about an axis orthogonal to the axis extending in the direction of travel 61 and an axis extending in the direction of gravity. The yaw angle θy corresponds to the position (angle) of the mobile apparatus 6 about an axis extending in the direction of gravity. The position of the mobile apparatus 6 changes during movement in accordance with, for example, the shape of the road or the expansion or contraction of the tires. A change in position changes the distance between the image capturing device 7 and the slope 200. The distance is hereinafter referred to as an “object distance”. A change in object distance changes the size of an image area corresponding to the slope 200 in the first image and the size of an image area corresponding to the slope 200 in the second image. The change in the object distance corresponds to a change in the relative position between the image capturing device 7 and the slope 200 in a direction substantially orthogonal to the direction of travel 61, and is an example of a change in the relative position between the image capturing device 7 and the slope 200.

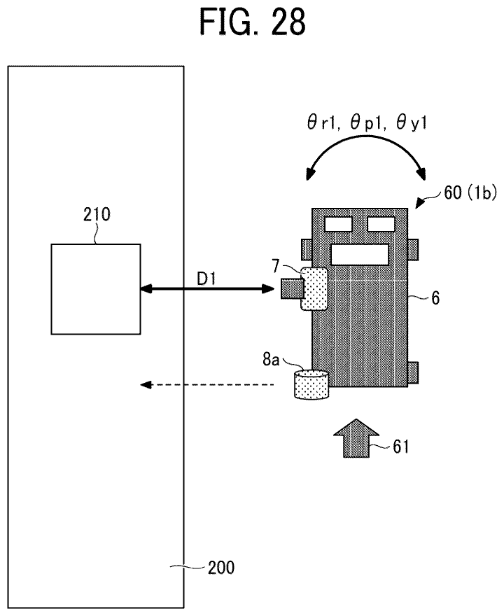

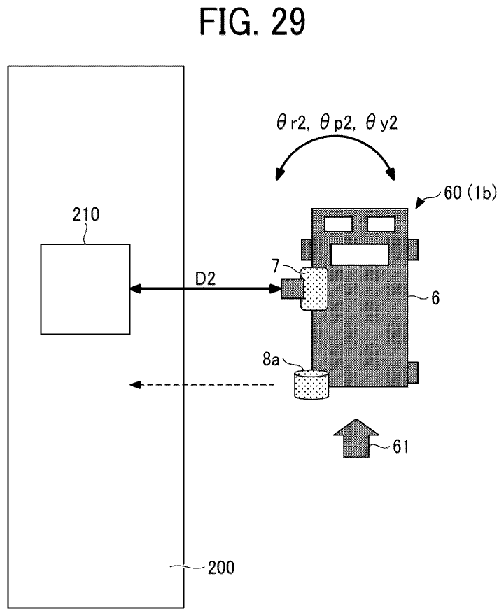

FIG. 28 illustrates an example situation for capturing the first image in a state inspection system 1b according to the present embodiment. FIG. 29 illustrates an example situation for capturing the second image in the state inspection system 1b. FIGS. 28 and 29 are schematic views of the mobile apparatus 6 moving in the direction of travel 61 on a road facing the slope 200, as viewed from above.

In the present embodiment, as in the first embodiment (see FIG. 21), the mobile apparatus system 60 moves twice in the direction of travel 61 on the road facing the slope 200, and captures the first image in the first movement and the second image in the second movement.

In the first movement, an image of the mark 210 on the slope 200 is captured at time T1 by the image capturing device 7 with an amount of exposure E1 and an object distance D1, and the mobile apparatus 6 has a roll angle θr1, a pitch angle θp1, and a yaw angle θy1. In the second movement, an image of the mark 210 on the slope 200 is captured at time T2 by the image capturing device 7 with an amount of exposure E2 and an object distance D2, and the mobile apparatus 6 has a roll angle θr2, a pitch angle θp2, and a yaw angle θy2. In the example illustrated in FIGS. 28 and 29, the object distance D2 is shorter than the object distance D1.

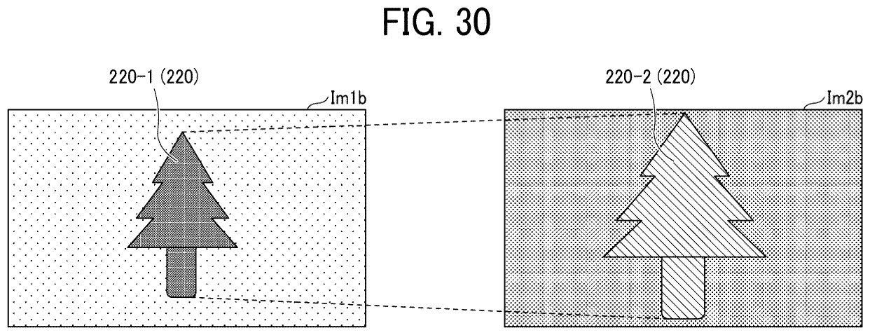

FIG. 30 illustrates an example in which the size of an image area corresponding to an object is different between a first image Im1b and a second image Im2b in accordance with the object distance. In FIG. 30 and FIG. 31 described below, the object is a tree 220, rather than the slope 200, for easy understanding.

In FIG. 30, since the object distance D2 is shorter than the object distance D1, an image area corresponding to a tree 220-2 in the second image Im2b has a larger size than an image area corresponding to a tree 220-1 in the first image Im1b. The difference in size between the image area corresponding to the tree 220-1 and the image area corresponding to the tree 220-2 may reduce the quality of a composite image of the first image Im1b and the second image Im2b.

In the present embodiment, the combining unit 55 changes the size of the image area corresponding to the tree 220 in at least one of the first image and the second image such that the image area corresponding to the tree 220 (object) in the first image and the image area corresponding to the tree 220 (object) in the second image have the same size.

FIG. 31 is an illustration of an example of a method of changing the size of an image area corresponding to the tree 220. In FIG. 31, the size of the image area corresponding to the tree 220-1 is changed to enlarge the image area corresponding to the tree 220-1 to obtain an image of a tree 220-1′ after the change.

In FIG. 31, image areas S1 to S36 are strip-shaped image areas extending in a vertical direction. Each of the image areas S1 to S36 corresponds to an image of one line captured by the image capturing device 7 serving as a line camera. The vertical direction corresponds to the vertical direction in the real space. The image capturing device 7 has 4000 pixels, by way of example. In each of the image areas S1 to S36, 4000 pixels are arranged in the vertical direction. The image capturing device 7 joins the image areas S1 to S36 together in a horizontal direction to obtain the first image Im1b. The horizontal direction corresponds to the direction of travel of the mobile apparatus 6 in the real space.

The combining unit 55 changes the size of the image area corresponding to the tree 220-1 in the first image Im1b such that the image area corresponding to the tree 220-1 in the first image Im1b has the same size as the image area corresponding to the tree 220-2 in the second image Im2b illustrated in FIG. 30.

In FIG. 31, the “image area corresponding to the tree 220-1” is an image area including, for example, the image areas S14 to S23. In the present embodiment, the combining unit 55 can change the size of at least an “image area corresponding to the tree 220”. In one example, the combining unit 55 does not change the size of the “image area corresponding to the tree 220-1”, but may change the entire image size of at least one of the first image Im1b and the second image Im2b to change the size of the image area corresponding to the tree 220. As described above, in the present embodiment, the first image Im1b and the second

image Im2b can be combined such that an image areas corresponding to the tree 220 in the first image Im1b and an image areas corresponding to the tree 220 in the second image Im2b have substantially the same size. Thus, the combining unit 55 can combine the first image Im1b and the second image Im2b with increased quality. In terms of an increase in the quality of a composite image obtained by the combining unit 55, it is preferable to move the mobile apparatus 6 without varying the object distance during capturing of images of the slope 200.

In the present embodiment, in one example, the state inspection system 1b does not change the size of the image area corresponding to the tree 220-1 in the first image Im1b, but may change the size of the image area corresponding to the tree 220 in at least one of the first image Im1b and the second image Im2b. In another example, the state inspection system 1b may change the size of the image area corresponding to the tree 220-1 in the first image Im1b in accordance with the detection result of the position of the image capturing device 7 obtained by the angle sensor 8c. Such examples can also achieve the same operations and effects as those described above.

The other operations and effects of the present embodiment are substantially the same as those of the first embodiment.

### Fourth Embodiment

Next, a state inspection system according to a fourth embodiment will be described. The present embodiment is mainly different from the first embodiment in that the combining unit 55 illustrated in FIG. 6 corrects the brightness of a composite image such that the difference in brightness between the first image and the second image in a joint area between the first image and the second image in the composite image is less than or equal to a predetermined brightness difference threshold.

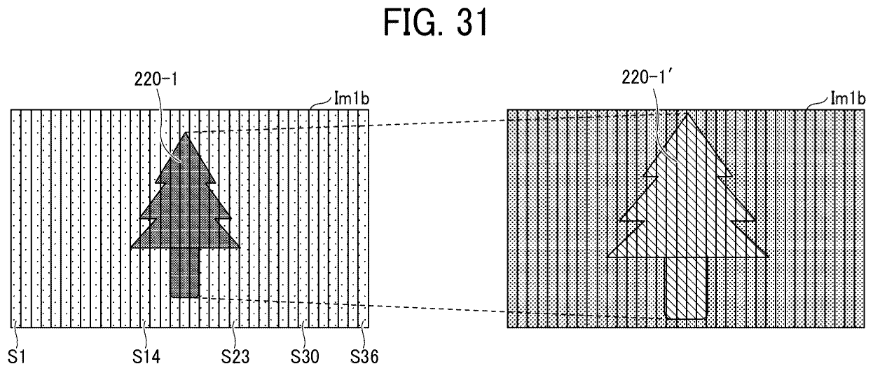

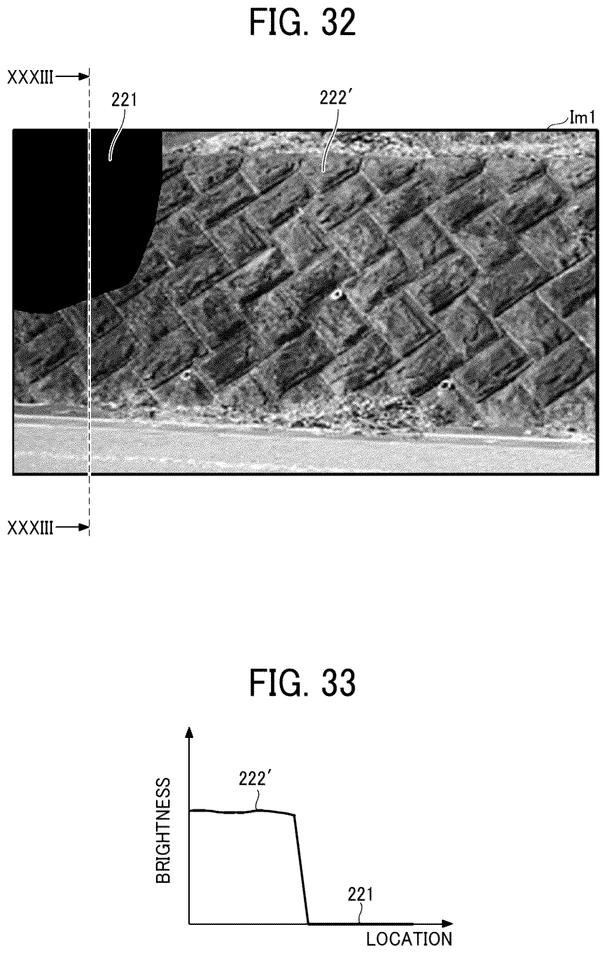

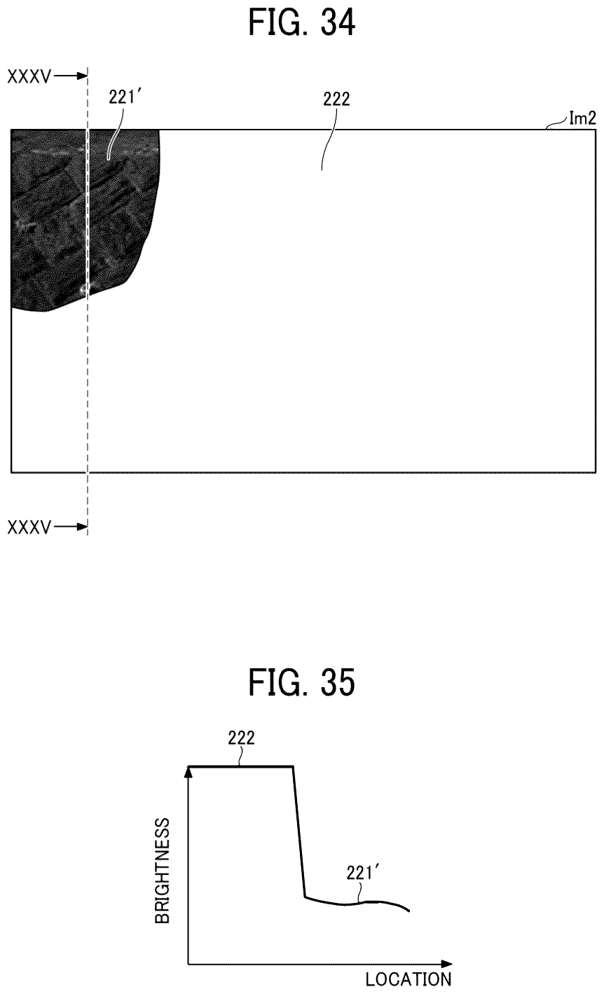

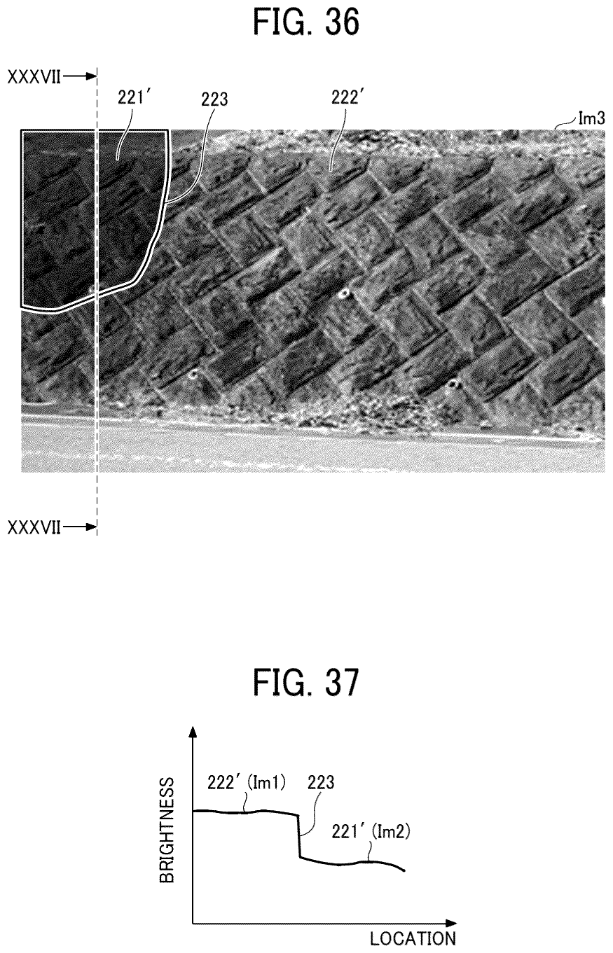

FIG. 32 is an illustration of an example of a first image Im1 according to the present embodiment. FIG. 33 is an illustration of a brightness distribution over a cross section taken along line XXXIII-XXXIII of FIG. 32. FIG. 34 is an illustration of an example of a second image Im2 according to the present embodiment. FIG. 35 is an illustration of a brightness distribution over a cross section taken along line XXXV-XXXV of FIG. 34. FIG. 36 is an illustration of an example of a composite image Im3 of the first image Im1 illustrated in FIG. 32 and the second image Im2 illustrated in FIG. 34. FIG. 37 is an illustration of a brightness distribution over a cross section taken along line XXXVII-XXXVII of FIG. 36.

The brightness distributions over the cross sections described above each refer to a distribution of brightness values of a plurality of pixels over a cross section taken along the corresponding line. The first image Im1 illustrated in FIG. 32 is captured by the mobile apparatus system 60 illustrated in FIG. 28, and the second image Im2 illustrated in FIG. 34 is captured by the mobile apparatus system 60 illustrated in FIG. 29.

As illustrated in FIGS. 32 and 33, in the underexposed image area 221 of the first image Im1, the brightness values of the pixels are 0, and the underexposed image area 221 has no difference in brightness of the pixels. As illustrated in FIGS. 34 and 35, in the overexposed image area 222 of the second image Im2, the brightness values of the pixels are maximum, and the overexposed image area 222 has no difference in brightness of the pixels. For example, in a case where an 8-bit color imaging element is used, the brightness value of each of red, green, and blue pixels have a maximum of 255 in gradation.

As illustrated in FIGS. 36 and 37, the composite image Im3 is obtained by combining the first image Im1 and the second image Im2 such that an underexposed image corresponding area 221′ in the second image Im2 and an overexposed image corresponding area 222′ in the first image Im1 are joined together. Since the underexposed image area 221 and the overexposed image area 222 are removed, the composite image Im3 has no blocked-up shadows or blown-out highlights.

In contrast, the composite image Im3 may have an unnatural difference in brightness in a joint area 223 corresponding to a joint between the first image Im1 and the second image Im2. The unnatural difference in brightness is caused by a difference between the amount of exposure with which the first image Im1 is captured and the amount of exposure with which the second image Im2 is captured. In the inspection of the slope 200, in the presence of both a difference in brightness in the composite image Im3 due to a defect such as a crack or a fissure in the slope 200 in the real space and a difference in brightness in the joint area 223 of the composite image Im3, the state inspection system may fail to distinguish between the two differences and may fail to detect the defect such as the crack or the fissure.

Accordingly, in the present embodiment, the combining unit 55 corrects the brightness of the composite image Im3 such that the difference in brightness between the first image Im1 and the second image Im2 in the joint area 223 between the first image Im1 and the second image Im2 is less than or equal to a predetermined brightness difference threshold.

For example, the combining unit 55 detects at least one of the underexposed image area 221 and the overexposed image area 222 from the first image Im1 and the second image

Im2. The combining unit 55 sets, as the joint area 223 of the composite image Im3, at least one of a joint between the underexposed image area 221 and an image area other than the underexposed image area 221 in the composite image Im3 and a joint between the overexposed image area 222 and an image area other than the overexposed image area 222 in the composite image Im3. The combining unit 55 corrects at least one of the average brightness of the entire first image Im1 and the average brightness of the entire second image Im2 such that the difference in brightness between the first image Im1 and the second image Im2 in the joint area 223 is less than or equal to a predetermined brightness difference threshold. Thereafter, the combining unit 55 combines the first image Im1 and the second image Im2. Through the operations described above, the combining unit 55 can correct the brightness of the composite image Im3 such that the difference in brightness between the first image Im1 and the second image Im2 in the joint area 223 is less than or equal to a predetermined brightness difference threshold. The brightness difference threshold is determined in advance such that a defect such as a crack or a fissure is detectable. The operations for setting the difference in brightness between the first image Im1 and the second image Im2 in the joint area 223 to be less than or equal to a predetermined brightness difference threshold is not limited to that described above and may be changed as appropriate in accordance with, for example, the characteristics of the slope 200.

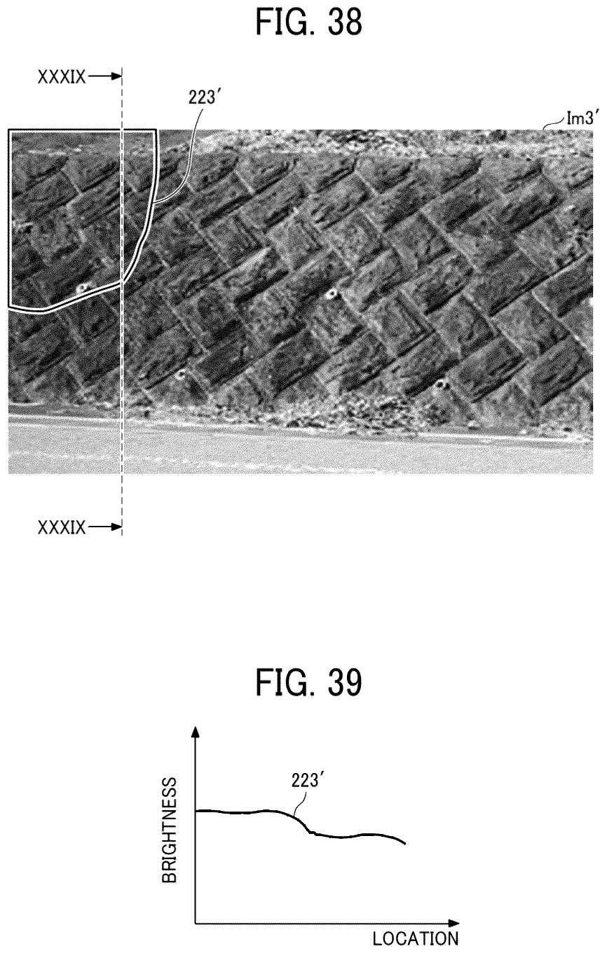

FIG. 38 is an illustration of an example of a result of subjecting the composite image Im3 illustrated in FIG. 36 to brightness correction. FIG. 39 is an illustration of a brightness distribution over a cross section taken along line XXXIX-XXXIX of FIG. 38. In FIG. 38, a composite image Im3′ is a composite image obtained by correcting the brightness of the composite image Im3. As illustrated in FIGS. 38 and 39, in the composite image Im3′, the difference in brightness is reduced in an area 223′ corresponding to the joint area 223 illustrated in FIG. 36, making the joint between the first image Im1 and the second image Im2 less noticeable. As a result, the state inspection system according to the present embodiment can avoid the presence of both the difference in brightness caused by a defect such as a crack or a fissure in the slope 200 in the real space and the difference in brightness in the joint area 223 of the composite image Im3 and detect the defect such as the crack or the fissure in the slope 200.

The present embodiment may also applied to a case where the first image Im1 and the second image Im2, which are captured by the mobile apparatus system 60a illustrated in FIGS. 25 and 26, are used to acquire the composite image Im3. In this case, the same operations and effects as those described above can also be achieved.

While an image capturing method, a program, an image capturing system, and an information processing apparatus according to some embodiments of the present disclosure have been described, the present disclosure is not limited to the embodiments described above. Additional embodiments may be implemented, or certain components may be changed or omitted so long as such implementations or changes can be conceived by a person skilled in the art and the operations and effects of the present disclosure can be achieved in any aspect within the scope of the present disclosure.

Each of the functions in the embodiments described above may be implemented by one or more processing circuits or circuitry. As used herein, the term “processing circuit or circuitry” includes processors programmed to implement each function by software, such as a processor implemented by an electronic circuit, and devices designed to implement the functions described above, such as an application specific integrated circuit (ASIC), a digital signal processor (DSP), a field programmable gate array (FPGA), a system on a chip (SOC), a graphics processing unit (GPU), and existing circuit modules.

Each of the tables in the embodiments described above may be each generated by learning effect of machine learning. In addition, in alternative to the use of the tables, the data of the items associated with each other may be classified by machine learning. Machine learning is a technology for making a computer acquire human-like learning ability. Machine learning refers to a technology in which a computer autonomously generates an algorithm to be used for determination such as data identification from training data captured in advance and applies the generated algorithm to new data to make a prediction. Any suitable learning method is applied for machine learning. For example, any one of supervised learning, unsupervised learning, semi-supervised learning, reinforcement learning, and deep learning, or a combination of two or more of those learning methods may be used.

Further, various tables in the embodiments described above may be each generated by using image processing technology. Examples of the image processing technology include, but are not limited to, edge detection, straight line detection, and binarization processing.

When voice is used, voice conversion technology such as Fourier transform may be used.

The following non-limiting examples illustrate aspects of the present disclosure.

In Aspect 1, an image capturing method is executed by an image capturing device that is mounted on a mobile apparatus and captures an image of an object during movement of the mobile apparatus. The image capturing method includes, by the image capturing device, capturing a first image of the object with a first amount of exposure while a relative position between the image capturing device and the object is constantly changing, and capturing a second image of the object with a second amount of exposure different from the first amount of exposure while the relative position between the image capturing device and the object is constantly changing.

According to Aspect 2, in the image capturing method of Aspect 1, image combining means acquires a composite image of the first image captured by the image capturing device and the second image captured by the image capturing device.

According to Aspect 3, in the image capturing method of Aspect 2, the image combining means acquires the composite image, based on a feature point in each of the first image captured by the image capturing device and the second image captured by the image capturing device.

According to Aspect 4, in the image capturing method of Aspect 2 or Aspect 3, image generation means generates a plurality of cross-sectional images related to a cross section of the object, based on the first image captured by the image capturing device and the second image captured by the image capturing device. The image combining means performs a comparison between the plurality of cross-sectional images generated by the image generation means to acquire the composite image.

According to Aspect 5, in the image capturing method of any one of Aspect 2 to Aspect 4, a three-dimensional sensor measures a three-dimensional surface shape of the object. Image generation means generates a plurality of three-dimensional surface images of the object, based on the three-dimensional surface shape measured by the three-dimensional sensor. The image combining means performs a comparison between the plurality of three-dimensional surface images generated by the image generation means to acquire the composite image.

According to Aspect 6, in the image capturing method of any one of Aspect 2 to Aspect 5, the image combining means changes a size of an image area corresponding to the object in at least one of the first image or the second image such that the image area corresponding to the object in the first image and the image area corresponding to the object in the second image have a same size.

According to Aspect 7, in the image capturing method of any one of Aspect 2 to Aspect 6, the image combining means corrects brightness of the composite image such that a difference in brightness between the first image and the second image in a joint area between the first image and the second image in the composite image is less than or equal to a predetermined brightness difference threshold.

According to Aspect 8, in the image capturing method of Aspect 7, the image combining means detects at least one of an underexposed image area or an overexposed image area from the first image and the second image, and sets, as the joint area in the composite image, at least one of a joint between the underexposed image area and an image area other than the underexposed image area in the composite image or a joint between the overexposed image area and an image area other than the overexposed image area in the composite image.

According to Aspect 9, in the image capturing method of any one of Aspect 1 to Aspect 8, the image capturing device is one of a plurality of image capturing devices, and the plurality of image capturing devices capture the first image and the second image while a relative position between each of the plurality of image capturing devices and the object is constantly changing.

In Aspect 10, a program causes the image capturing device to execute the image capturing method of any one of Aspect 1 to Aspect 9.

In Aspect 11, an image capturing system includes an image capturing device and an information processing apparatus. The image capturing device is mounted on a mobile apparatus and captures an image of an object during movement of the mobile apparatus. The information processing apparatus processes the image captured by the image capturing device. The image capturing device captures a first image of the object with a first amount of exposure while a relative position between the image capturing device and the object is constantly changing, and captures a second image of the object with a second amount of exposure different from the first amount of exposure while the relative position between the image capturing device and the object is constantly changing.

In Aspect 12, an information processing apparatus processes an image captured by an image capturing device that is mounted on a mobile apparatus and captures an image of an object during movement of the mobile apparatus. The image capturing device captures a first image of the object with a first amount of exposure while a relative position between the image capturing device and the object is constantly changing, and captures a second image of the object with a second amount of exposure different from the first amount of exposure while the relative position between the image capturing device and the object is constantly changing. The information processing apparatus includes an image combining means. The image combining means acquires a composite image of the first image and the second image.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. An image capturing method executed by an image capturing device that is mounted on a mobile apparatus and captures an image of an object during movement of the mobile apparatus, the image capturing method comprising:
capturing a first image of the object with a first amount of exposure while a relative position between the image capturing device and the object is constantly changing; and
capturing a second image of the object with a second amount of exposure different from the first amount of exposure while the relative position between the image capturing device and the object is constantly changing.

2. The image capturing method according to claim 1, further comprising
acquiring a composite image of the first image and the second image each captured by the image capturing device.

3. The image capturing method according to claim 2, further comprising
acquiring the composite image, based on feature points in the first image and the second image each captured by the image capturing device.

4. The image capturing method according to claim 2, further comprising
generating a plurality of cross-sectional images related to a cross section of the object, based on the first image and the second image each captured by the image capturing device, wherein
the acquiring of a composite image includes:
performing a comparison between the plurality of cross-sectional images that are generated; and
acquiring the composite image based on a result of the comparison.

5. The image capturing method according to claim 2, further comprising:
measuring, by a three-dimensional sensor, a three-dimensional surface shape of the object; and
generating a plurality of three-dimensional surface images of the object, based on the three-dimensional surface shape measured by the three-dimensional sensor, wherein
the acquiring of a composite image includes:
performing a comparison between the plurality of three-dimensional surface images that are generated; and
acquiring the composite image based on a result of the comparison.

6. The image capturing method according to claim 2, further comprising
changing a size of an image area corresponding to the object in at least one of the first image or the second image such that the image area corresponding to the object in the first image and the image area corresponding to the object in the second image have a same size.

7. The image capturing method according to claim 2, further comprising
correcting brightness of the composite image such that a difference in brightness between the first image and the second image in a joint area between the first image and the second image in the composite image is less than or equal to a brightness difference threshold.

8. The image capturing method according to claim 7, further comprising:
detecting an underexposed image area from the first image and the second image; and
setting, as the joint area in the composite image, a joint between the underexposed image area and an image area other than the underexposed image area in the composite image.

9. The image capturing method according to claim 7, further comprising:
detecting an overexposed image area from the first image and the second image; and
setting, as the joint area in the composite image, a joint between the overexposed image area and an image area other than the overexposed image area in the composite image.

10. A non-transitory recording medium storing a plurality of instructions which, when executed by one or more processors, causes the processors to perform the image capturing method according to claim 1.

11. An image capturing system comprising:
an image capturing device mounted on a mobile apparatus to capture an image of an object during movement of the mobile apparatus; and
an information processing apparatus to process the image captured by the image capturing device, wherein
the image capturing device captures a first image of the object with a first amount of exposure and a second image of the object with a second amount of exposure different from the first amount of exposure, while a relative position between the image capturing device and the object is constantly changing.

12. The image capturing system according to claim 11, further comprising
a plurality of image capturing devices including the image capturing device, wherein
the plurality of image capturing devices capture the first image and the second image while a relative position between each of the plurality of image capturing devices and the object is constantly changing.

13. An information processing apparatus comprising circuitry configured to:
receive a first image and a second image from an image capturing device that is mounted on a mobile apparatus and captures an image of an object during movement of the mobile apparatus while a relative position between the image capturing device and the object is constantly changing,
the first image being an image of the object and captured with a first amount of exposure,
the second image being an image of the object and captured with a second amount of exposure different from the first amount of exposure; and
acquire a composite image of the first image and the second image.
